(19) United States
(12) Patent Application Publication
(10) Pub. No.: US 2015/0324525 A1
(43) Pub. Date: Nov. 12, 2015

(54) PATIENT CONTROLLED ELECTRONIC MEDICAL RECORD SYSTEM

(71) Applicant: Bruce Nathan Saffran, Columbus, NJ (US)

(72) Inventor: Bruce Nathan Saffran, Columbus, NJ (US)

(21) Appl. No.: 14/588,297

(22) Filed: Dec. 31, 2014

Related U.S. Application Data
(60) Provisional application No. 61/990,130, filed on May 8, 2014.

(51) Int. Cl. G06F 19/00

(52) U.S. Cl. CPC G06F 19/322; G06Q 50/01

(57) ABSTRACT

A computer system and method for management of electronic medical records. The system includes the facility to share patients' medical records amongst multiple healthcare providers and other organizations, as permitted by each individual patient, and providing social networking tools to facilitate interactions between the various parties and the electronic medical records.

### CLAIM OF PRIORITY

The instant application claims the benefit of priority under 35 U.S.C. §119(e) to U.S. Provisional patent application Ser. No. 61/990,130, entitled “Patient Controlled Electronic Medical Database”, filed May 8, 2014, which is incorporated herein by reference in its entirety.

### TECHNICAL FIELD

The technology described herein generally relates to management of electronic medical records, and more particularly relates to ways of sharing patients' medical records amongst multiple healthcare providers and other organizations, as permitted by each individual patient, and providing social networking tools to facilitate interactions between the various parties and the electronic medical records.

### BACKGROUND

The amount of money spent on repeated diagnostic tests and avoidable hospital admissions in the United States is estimated at over $750,000,000,000 per year. Much of this money could be saved if providers had easy access to tests, laboratory studies, and procedure notes from prior examinations of patients carried out at other venues. Currently, however, medical data is very cumbersome to share between treating facilities such as hospitals, clinics, and physician's offices and it becomes easier and quicker to repeat a test than to obtain the result of the same test that was carried out previously at another facility. Although this difficulty can be attributed to multiple reasons, two of the most significant are: 1) The Health Insurance Portability and Accountability Act of 1996 (HIPAA), which requires patient permission to electronically disseminate medical information between facilities or providers; and 2) a resistance of treating facilities to share data in part due to a fear of “losing the patient” to a competing facility or provider. Though these reasons are not in themselves technical, they could actually be overcome with appropriate technological advances.

At present, in order to change from one doctor, hospital or treatment facility to another, a patient must either remember to bring a copy of their medical records, old films and laboratory data to their new treating facility, or must request that the prior facility where the images or data were generated transmit the films and/or data to the new facility. This process may take days, or may require numerous phone calls and faxes or even trips to the former facility. Because this process is so burdensome, many patients or the new facilities themselves elect to simply have the tests repeated to avoid the hassle of getting the old data. In some cases a patient may give up on the idea of getting a “second opinion”. In addition to severely curtailing the freedom of patients to manage their own health and health records by using the provider of their choosing, this lack of record portability also results in considerable wasted time and money, which affects individuals, institutions and the economy overall.

Electronic health records have shown promise in addressing these limitations, but have fallen short in several significant ways. Furthermore, these products have been very slow to be adopted and have been, in general, very disappointing. The electronic health products generally fall into two categories: Personal health records (PHR), and Electronic medical records (EMR).

PHRs are databases that contain personal health information that can be entered by the patient. These databases allow a patient, family members, or other designated persons access and the ability to share stored health information. They provide patients with an online repository of their information and an ability to share that information with their doctor(s), emergency responders, and family. These databases have been adopted very slowly, perhaps because of cumbersome user interfaces and difficulty for users to perform the operations outlined in the PHR description. Furthermore, PHRs do not embody attributes of social networks, and as such are not suited for communicating live updates and for sharing with multiple actively linked users and providers.

Current medical data repositories (such as EMRs) have been designed to comply with the HIPAA regulations. That is, they allow secure and documented communication pathways between providers. These solutions allow for two-way privileged communications between a patient and a provider, or between providers on behalf of the patient, but not multi-way communications and are also not built on social network platforms. In these systems, every communication is logged and archived. There are many variants of EMR systems, but the different variants very rarely “talk” to each other easily, meaning that sharing of data between them is impeded. Furthermore, HIPAA compliance is expensive and requires both patient and provider access to be via HIPAA compliant computer systems. In order for a patient to access his or her records electronically (and only those records that the facility chooses to upload), he or she must log in to a facility's portal and use their unique ID. The patient must do this for each treating facility he or she attends, although many do not have their own portal access systems. Furthermore, the patient must remember in which facility they had each test, and the result or report that the patient wants to view must be loaded into the system by the facility that carried out the test to be available electronically to the patient.

Consequently, what is needed is a platform that is widely available and that will allow patients to easily and securely “link” with providers so that the providers can access the patients' old records and their other health information at the time they are needed, wherever they are needed, regardless of which facility generated the data or when it was generated. Furthermore, a patient should be allowed to link with other like-minded individuals and groups to share experiences and medical information, without compromising the protections offered by HIPAA. Additionally, physicians should be able to link across town or across the world to coordinate care, plan conferences, or discuss developments in their specialties. A patient should be able to log in on any device with web access, whether it be his or her mobile device or a desktop computer, and be able to see and share all of his/her data regardless of where it was generated. The patient should have control of his or her data, and be able to share any or all of it with whomever he or she chooses, whenever he or she wishes. Furthermore, this solution should not depend on the timeliness or immediate cooperation of the hospital, clinic, or physician's office that generated the original data. Much of this capability is akin to a “social network” that is already familiar in its operation to many users of the medical system. Patients have a legal right to access and copy their own medical information whenever they wish, and the patient should not be at the mercy of a facility being “closed”, backlogged with requests, or its staff being “on break”, or “too busy”.

Health information can be complicated and intimidating. A major hindrance to adoption of any electronic health information system is familiarity and ease of use. Patients need to feel comfortable with how a social network works and how to use it. An electronic health information system needs to be designed and implemented in such a way that its operation feels similar to something a patient has done countless times before.

The discussion of the background herein is included to explain the context of the technology. This is not to be taken as an admission that any of the material referred to was published, known, or part of the common general knowledge as at the priority date of any of the claims found appended hereto.

Throughout the description and claims of the instant application the word “comprise” and variations thereof, such as “comprising” and “comprises”, is not intended to exclude other additives, components, integers or steps.

### SUMMARY

The present disclosure provides for an exemplary computer system for managing access by multiple parties to electronic medical data, the system comprising: a server configured to: receive electronic medical data from a plurality of patients; and provide access to the electronic medical data by a plurality of third parties, for example given appropriate permissions, wherein the server is connected to a network of computing devices, wherein the server and network of computing devices are configured to provide social network functions to the plurality of patients and the plurality of third parties, wherein the third parties are selected from: family members, doctors, medical facility staff, insurance providers, and other patients; a database of electronic medical data from the plurality of patients, stored on the server; at least one computing device configured to accept a patient's electronic medical data from the patient (or a provider), wherein the data comprises a plurality of items of information; an interface on the at least one computing device through which the patient optionally assigns to each item of information an access level, wherein the access level determines which third parties have permission to access the item of information, a network connection configured to transmit the patient's electronic medical data to the database; and at least one computing device configured to permit one or more of the third parties to access the items of information according to the access levels that are set by the patient, or by the system.

In one aspect the social network functions of the system further comprise: messaging between one or more of the plurality of patients and one or more of the plurality of third parties, amongst the plurality of third parties, and amongst the plurality of patients; establishing connections between the plurality of patients and the plurality of third parties, amongst the plurality of third parties, and amongst the plurality of patients; communicating updates from a patient to one or more of the plurality of third parties to which the patient has established a connection; message-board functions for topics of interest to the plurality of patients, to which the plurality of patients and the plurality of third parties can post information, and tools for patients to create, edit, and publish summaries of their personal history for viewing by other patients and the plurality of third parties.

The present disclosure includes one or more exemplary processes, performed on one or more computing apparatus, for managing access by multiple parties to electronic medical data, and providing social media functions to patients and third parties.

The present disclosure can additionally include a computer readable medium, encoded with instructions for carrying out one or more processes for managing access by multiple parties to electronic medical data, and providing social media functions to patients and third parties.

### BRIEF DESCRIPTION OF THE DRAWINGS

FIG. 1 is an illustrative schematic of some of the options available to a patient for linking and sharing data.

FIG. 2 illustrates the fact that a provider can be “linked” with several patients at once.

FIG. 3 illustrates a typical patient data share Venn diagram.

FIG. 4 is a depiction of how the network handles selective data sharing.

FIG. 5A illustrates how a charitable organization might reach out and broadcast their message to patients who have linked with it.

FIG. 5B demonstrates an example of how several health care business entities can use the group functionality of the invention to interact and bid for business with a purveyor of medical services, in this case, a fictional provider of ambulance services, Ace Ambulance Services.

FIG. 6 is a schematic of how an unmediated patient support group discussion can proceed on the network.

FIG. 7 illustrates how a patient-care team might use the network to monitor patients who have been discharged to home from the hospital.

FIG. 8 illustrates how a patient can link with a radiology department, and thus permit his or her old radiographs to be compared with his or her new ones.

FIG. 9 depicts how the network can be used to create a composite medical record for a patient by aggregating data from multiple facilities.

FIG. 10 shows an additional embodiment of the network whereby the patient has given Provider 1 permission to download his profile onto a HIPAA compliant computer system, and share it with colleagues, comment on it, and potentially provide a uniform care plan to the patient.

FIG. 11 is a depiction of how, using a bridge program like EMRlink, the network can combine selected elements from EMRs of different vendors into a much more manageable and user-friendly record, e.g., the “Network's EMR”, for all concerned.

FIG. 12 is an additional illustration of how selected portions of a full EMR can be combined using the Invention into an organized, user-friendly, and manageable whole.

FIG. 13 represents a screen-shot of an exemplary home page of a patient, as stored on the computer network application of the present invention.

FIG. 14 represents an exemplary screen-shot of results from a provider (or member) search.

FIG. 15 illustrates an exemplary screen-shot of the network during patient data sharing.

FIG. 16 represents an exemplary screen-shot of a patient adding their medicines to their profile using the search bar and the check-boxes on the right.

FIG. 17 depicts an exemplary screen-shot of a process of adding items from a patient's past or current medical history.

FIG. 18 is an exemplary screen-shot of an allergies entry page. For each stated allergy, there is a pop-up that asks the patient: “What happens if you get it?”

FIG. 19 is an exemplary representation of radiographs, and other imaging studies that have been added to the network by the patient. Each entry displays a thumbnail of the study and the date of the test.

FIG. 20 demonstrates an example of how text could be entered into the Health Status Bar to notify hospital personnel of a patient's health status post discharge. There are three parts to the figure, representing three examples of entries.

FIG. 21 demonstrates an example of the invention being used for a “wellness” program.

FIG. 22 shows an exemplary computer system for practicing the invention.

Like reference symbols in the various drawings indicate like elements, and are as follows, and as referenced and described elsewhere herein:
10 Logo of a brand of the invention
20 Member search bar
25 Profile picture of the active user
30 Home page activity tab
40 Manage connection tab
50 Share Overview tab
60 Button to print invention profile
70 Export button to permit electronic transfer of invention profile data
80 Demographic info tab
90 Past Medical History tab
100 Allergies tab
110 Current medicines tab
120 Past Surgical History tab
125 Health Status link
130 Implants and devices tab
140 ECG tab
150 Radiographs tab
160 Privacy Policy link
170 Terms and conditions link
180 Shared Icon indicating that a section has been shared
190 Search button
200 Identity tab of person or entity that is signed in
210 Heading for the column of providers with whom patient is linked
220 Time remaining on the link
230 Name of section of the profile information that has been shared
240 Name of provider with whom section has been shared
250 Profile of provider or entity with which data has been shared.
260 Link for complete list of providers who have seen data.
270 Update feed
280 Icon indicating that there is not a link currently
290 Icon indicating a current link with a physician on the Invention
300 Icon indicating a current link with an organization
305 Registration number of provider
310 Button to allow immediate cessation of sharing privileges
320 Button to renew sharing for a new time interval
330 Button to renew privileges of someone whose privileges have expired
340 Profile of a physician whose privileges have expired
350 List of medicines loaded by the patients on the network
360 “X” to remove medicine from list
365 The name of a specific medicine that has been loaded.
370 Field to add a new medicine to the patient's invention profile.
380 Search Bar to find medicines
390 Icon to indicate the medicine has been added
400 Icon to indicate the medicine is yet to be added
410 Name of a medicine on the list of choices
420 Section in a patient's Past Medical History entry form
430 Icon indicating that the patient wishes to add this condition to profile
450 Icon indicating that this remains an option to add to the profile
460 Indicator bar showing shares of this information
470 Icon indicating that an allergy exists for this drug
480 Icon indicating an option for choosing this to be added to profile
485 Drop down menu for allergy symptoms
500 Icon permitting upload of data to this section
510 Section of the radiograph record for CT scans.
520 Indicator that no CT scans have been uploaded
530 Section containing “Plain Film” radiographic images
540 Plain Film radiographic image
550 One-way arrow for information flow from patient to provider
560 Two-way arrow for communication with a non-clinical entity
570 One-way arrow for information flow from patient to clinical care team
580 Patient data not loaded into the Invention
590 Entirety of single patient dataset loaded on the Invention
600 Data shared with Physician 2
610 Data shared with Physician 3
620 Data shared with both Physician 2 and Physician 3
630 Section of the invention profile
640 Shared portion of section of invention profile
650 Non-shared portion of the invention profile
660 Collated and organized section of all shared portions of profile
665 Health Status entry bar
670 Data from a recently discharged patient doing well
680 Data from a recently discharged patient doing poorly
685 Data from an electronic wearable health-monitoring device
700 HIPAA wall
710 Radiology department page
720 Radiology PACS
730 Provider not in HIPAA compliant environment
740 Invention EMR
750 Provider in HIPAA compliant environment who has linked with a patient
760 Provider in HIPAA compliant environment who has not linked with a patient
770 Vendor 1 EMR
780 Vendor 2 EMR
790 Vendor 3 EMR
800 Fitness data
810 Blood Sugar measurements

### DETAILED DESCRIPTION

### Overview

In one aspect, the invention comprises a secure, cloud-based, social network that, rather than storing family photos or career milestones in the more typical sense of a social media application, is designed to store, retrieve and link medical information among patients and providers. As with other social networks, patients using the invention have exclusive control of the data within their personal record. Thus, the underlying principle of this aspect of the invention is that it provides a secure way for patients to store and control access to their health data, as well as to link with third parties in the healthcare space. Patients can link and share information at their discretion with a third party such as a physician, a group of physicians, other patients, health organizations, health-related businesses, charities, or a specific care-team, such as a cancer-care team. Because this aspect of the invention is carried out over computer networks, the third parties may be located just across town, or anywhere in the world. The network, and a patient's home page within it, can be accessed to provide a longitudinal record of all of a patient's health activity regardless of when or where the care was rendered. (The term “longitudinal” as used herein refers to a sequence over a period of time, such as chronological.) Consequently, patients do not have to rely on rapid cooperation from a specific hospital, physician's office, imaging center, insurance carrier, or clinic to obtain their own data in a timely manner. A patient can simply log in to the network on any web-accessible device such as a desktop computer or a mobile device, and be able to see, share and comment on any or all of his/her data regardless of where or when it was generated. The network can also provide access to an easy to read summary of medical data, available wherever a patient moves or travels. It doesn't matter where the patient is employed or who their employer is, or who their insurance carrier is, or which member of the patient's family has the insurance coverage, in any situation the patient controls which parties can access their stored health data.

In one aspect, the invention makes it possible to achieve through networked computer technology what was not previously possible, either with computer networks or through other means: an ability to swiftly and securely share health records amongst multiple parties, while allowing a user to maintain control over the records, coupled with an ability to integrate numerous parties into a single forum for sharing and manipulating health related data.

### DESCRIPTION OF VARIOUS EMBODIMENTS

The invention and a patient's page within it can be used to access the singular common repository for a patient's medical information, and is accessible to the patient from anywhere. By accessing data on the network, data serving as a lifetime longitudinal medical data record for the patient can be accessed wherever a patient moves or travels. In contrast to Electronic Medical Records, which contain a legal record of all correspondence between patient and hospital staff/physician, the exemplary network allows the patient to load and share only what he or she wishes, and allows the patient to add, delete, or modify contents at will.

Information on the network can be shared, for example, between patients, medical organizations, groups, employers, and providers, all depending on the user's wishes. Patients, employers, hospitals, charities, and businesses can all form groups and interact with each other. Group formation and communication between interested parties on the network provides the means to rapidly exchange information on the supply, demand, and pricing of medical goods and services, either locally or on a nationwide basis.

Patients can “link” with providers who are also members of the network and, once linked, the provider has access to some or all of the patient's stored information for a set period of time, or indefinitely. Once “linked”, a third party, such as a healthcare provider, has access to some or all of a patient's stored information, depending on the permission granted by a patient. In contrast to hospital or clinic EMRs, which contain a complete record of all health data and communications between a patient and their physician(s), the network allows a patient to load and share only what he or she wishes, and allows a patient to add, delete, or modify contents at will.

Similar to the way in which other social networks operate, changes to a patient's information can be broadcast to those third parties the patient chooses to share it with. For example, patient activity will appear on a provider's update panel, should the patient be contemporaneously linked to that provider. A patient can be linked with many providers at the same time, and a provider can be linked to many patients simultaneously. Thus, two physicians can view the update panel of a single patient at the same time if both are given permission by that patient, and both physicians are linked to the patient at the same time. This “linking” relationship can be temporarily or permanently suspended should one of the parties make such a request.

The data entry constructs can be similar to the intake forms that patients fill out every time they visit their physician's office or clinic. Other data, e.g., images or other diagnostic data, can be entered into the invention in a manner very similar to adding photos or documents on currently popular social networks such as FaceBook, Google+, or LinkedIN. Documents can also be loaded into the invention directly by a patient, or from diagnostic venues, e.g., hospitals, clinics or laboratory facilities. EMRs or photocopies of notes from a doctor's office, as well as e-mails or text messages from providers can all be organized by the patient on a patient's page in the network. Data from wearable devices can also be entered directly on the health status bar (665) feature of the invention, saved, and transmitted to providers immediately at the time of posting.

Patients can link with other patients in the network to form groups, e.g., to discuss a rare condition and to inform each other on developments and new treatments. Information on the network can be shared, for example, between patients, medical organizations, groups, employers, and providers, all depending on the user's wishes. Patients, employers, hospitals, charities, and businesses can all form groups and interact with each other. This ability to form groups, and exchange information on the availability of goods, services, and pricing provides exceptional price transparency, as well as a marketplace for medical goods and services on the network of the invention. If a HIPAA release is signed by a patient, thereby allowing upload of his or her records to the network, any provider linked to that patient can upload a copy of their notes, data, or diagnostic results directly to the patient's record on the network. If a patient gives permission and links with, for example, a radiology department account, old images having been previously loaded on the network (regardless of where they were generated), can be loaded on the radiology Picture Archiving and Communication System (PACS) and placed adjacent to the more recent ones for direct comparison. Images from microscope slides can be shared and read in similar fashion in the pathology department. In one aspect, the current invention can integrate with a PACS, depending upon the various permissions and security requirements set by the radiology department. In other embodiments, the invention and the PACS co-exist, side by side.

In a principal embodiment, the invention comprises a single layer, a non-HIPAA compliant layer, as described elsewhere herein. This layer has a lower level of functionality, and can be available on any computer system because it does not have to have HIPAA tracking software, and a user doesn't need authentication. A provider can access patient data in the non-HIPAA layer but can't move it around or save it. This layer provides just read-only functionality for the digital data, but the provider can print the data. If printed, the provider must still protect the confidentiality of the hard copy under HIPAA law. A second HIPAA-compliant layer for healthcare providers can be added to the principal embodiment to increase functionality as described herein. Additional functionality can be provided by the second layer that embodies HIPAA-compliant tracking and security features. Providers can log in to this layer if they need to establish greater access to the data (such as sharing it with other providers, or presenting the data at a conference), consistent with HIPAA regulations. Once the provider has logged in, the invention allows the non-HIPAA program to talk to the HIPAA program via an authentication system. In this (HIPAA-compliant) layer, every transaction of electronic data has to be logged, which makes it more expensive to implement. HIPAA data includes a log of when the document moves (e.g., is copied, e-mailed, or downloaded), and shows who has seen the document. In additional embodiments, tabs can be added, e.g., InsuranceLink or EMR-Link to either the non-HIPAA-compliant, or HIPAA-compliant layer, as desired by the end user.

In one aspect, the invention can be implemented in a modular manner, for example in a single layer, or several layers each with tabs within a browser-type interface.

A non-PACS networked computer screen or screens can also be pulled up alongside of the department PACS screens to compare images directly from the network with those on the PACS screen without integration into the hospital PACS. In the provider screen of the principal embodiment, other organizations, e.g., malpractice insurance carriers or Continuing Medical Education providers, can share information to chosen specialties of physicians via a modular plug in. When an additional embodiment, a HIPAA-compliant layer, is appended to the principal embodiment, physicians can link with each other and discuss care of a specific patient or a group of patients, e.g., at an upcoming hospital cancer conference, or simply message between themselves in a secure HIPAA-compliant environment.

In an additional embodiment, the network allows a patient to organize and keep track of the costs of each visit (even those before they occur), benefits, and payments from all of his or her insurance products, e.g., Major Health, Health Savings Account, Supplemental Health, Disability, Voluntary benefits, MediGap, Dental, etc. On this tab, the health services desired (or utilized), can be subtracted from the balance of an account, applied to an insurance product, or applied to a deductible depending on the circumstances. By linking the carrier payment information with the pricing from providers within the invention, patients have unprecedented price transparency and can see exactly what they will be responsible for paying before they get or use a service. Third party modules (plug-ins) can be imported to patient, provider, and group screens to increase functionality.

Communication of patient-specific medical data, however, is only one-way, i.e., in one direction, from patient to provider. In the principal embodiment, providers are given “read only” permission to the patient data on the network in order to avoid the network and its contents becoming a legal medical record, and as such, unable to be modified by a patient. Of course, copies of a patient's true legal medical record can be obtained from his or her provider(s) and uploaded to the network separately, but this upload is simply a copy of the original and the data within the network can be deleted or shared like any other data. A patient can choose to share some, all, or none of the data with whomever he or she chooses. Different providers can be given different viewing privileges. For example, a patient may not wish to share the fact that he has colon cancer with his dentist.

Documents such as emails or text messages from providers can be loaded into the network directly by a patient. If a patient wishes to allow upload of medical records directly from the provider to the network (which may require a HIPAA release for the provider), any provider can upload a copy of their notes, data, or diagnostic results directly to the patient's record on the network. Because the uploaded records are a copy, a patient is free to delete any part, or all, of them if he or she wishes.

The duration of data sharing is completely up to the patient and may vary between providers. One provider can be given full privileges, whereas another could be given, for example, permission to only view old radiographic studies for two hours. A patient, his or her representative, or the provider, can view the data by accessing a secure cloud server using either a mobile device such as a tablet, or via a desktop portal. The features of the network also offer the patient the ability to view or rapidly transmit his or her data to his or her physician or other provider at a moment's notice, whatever information the provider requests in order to care for the patient.

Patients are also able to “link” on the network with other patients or with organizations such as cancer societies or support groups, and are able to broadcast their thoughts, or health data, to the group, if so desired. The broadcast of health data can be particularly useful in cases of research studies, rare diseases, “big data” projects, drug development projects, and side effect reporting. Patients can also link with their insurance provider or employer to receive, for example, notices, or special offers relating to their health, or ways to reduce their premiums. The patient need not share any health information with these organizations to be a part of a group. They simply need to “link” with the organization (and share “none” of their data), and the organization's broadcasts will appear on their patient update panel. In the principal embodiment, this group membership functionality is accomplished by the “share indefinitely” link setting.

Using the group function, information on the network can be shared between patients, insurance carriers, employers, and providers. For example, the invention is ideally suited for employee wellness initiatives. Research has shown that adoption of these initiatives has been slowed because a major worry of employees is that their employer will get hold of medical information that the employee wishes to keep private. The invention, however, allows sharing of only a single section of data if the patient wishes, and the employee can rest assured that the other information is not shared. If “wellness data” is entered on the “health status” bar of the invention, and, if “health status” is the only section shared with the employer, then the “wellness data” is the only data that the employer can see.

Information shared and broadcast on the group function can also include both pricing and availability for medical goods and services. For example, in a group formed for “Ambulance Services, Cleveland Metropolitan Area”, insurance carriers can openly bid on prices of ambulance services for their patients with ambulance providers in the Cleveland Metro area. Dialysis clinics, and nursing homes can also join the bidding for the same services, if they so choose. An ambulance provider could provide tier pricing or offer volume discounts—all using the group market place on the invention. Similarly, a group showing available rehab center beds could also be formed on the invention, and insurance carriers, hospital systems, or SurgiCenters could bid on open beds at different facilities for their patients. Patients with high deductible health plans, or with poor insurance coverage can price shop for the best deal on an MRI scan around town. MRI slots at 10 pm could potentially be cheaper than those at 2 pm. Patients or carriers looking for assisted living facilities, or home health aides, or wheelchair rentals could all find what they need using the group function, and get the best price available. Hospital/Physician groups could combine to offer discounts for elective surgical procedures offered at certain slow times or periods of unusually high availability, or a cancellation, similar to the way airlines price seats on flights. The group broadcast function of certain embodiments of the invention is ideal for this. For example, all patients in the Cleveland Metro area who need an elective total knee replacement surgery could join a group and be notified if a slot became available in the Cleveland area that would meet their time constraints and budget. Depending on the price (and out of pocket costs), a patient could get a needed surgical procedure for much less than they would normally have to spend if they scheduled it routinely. The hospital offering the procedure would simply need to post the date and details, and the patient could decide if it was right for them. Depending on the discount and location, it may make financial sense for patients to travel across the country or to neighboring states to take advantage of a good deal. This also makes sense for efficient use of hospital and physician resources. Hospitals and doctors only make money when they are busy, and a steady workload is much better than a “feast or famine” cycle. Consequently, the “market making” group functionality of the invention maximizes efficiency, and the price transparency of the invention minimizes the costs of goods and services. A group can also be formed on the invention for the purpose of broadcasting emergency room wait times, and patients could compare which wait was the shortest.

In this aspect, the invention puts the price of medical goods and services out in the open, for patients to see just like if they were buying a consumer product such as a refrigerator, or airline seats, or a car. The prices of these items can fluctuate according to supply and demand, and everyone should be able to benefit from the most efficient use of resources. Patients have the right to ALL of their health information, whenever they want it. In one aspect, the invention, for the first time, gives them the power to view it and make use of it, for example to identify services at the best price, in real time.

Doctors, and the care they provide patients, also benefit greatly from the invention. In addition to collating all of a patient's data in one place, which allows a physician to analyze it as a whole over time instead of in bits and pieces, aspects of the invention allow a physician to see if a critical test has been missed, or a stone has been left unturned. Not only can this benefit the patient, but also it decreases the physician's malpractice liability. In one embodiment, the invention is ideal for organizing patient complaints into “Problem Lists”, and assisting physicians in following practice guidelines or evidence based medicine. Practice guidelines can easily be uploaded into the invention and organized by ICD or by DRG, and the provider screen used to “check off” steps or milestones as they are reached. Custom checklists can be created or uploaded in the provider screen to comply with hospital policy, or to maximize physician revenue, or minimize the risk of missing an important step or test so to reduce malpractice risk. Third party modules, e.g., from malpractice carriers, can also be uploaded to the provider screen to assist in these functions. Alerts can be set so that doctors remember to order specific tests every three months, e.g., dialysis fistula flow analysis, or yearly mammograms.

In an additional embodiment, the invention has a specific feature, in an exemplary embodiment referred to as “InsuranceLink”, where a patient can organize and keep track of the benefits and payments from all of his or her insurance products, e.g., Major Health, Health Savings Account, Supplemental Health, Disability, Voluntary benefits, MediGap, Dental, etc. Within this feature, the health services desired (or utilized), can be subtracted from the balance of an account, applied to an insurance product, or applied to a deductible depending on the circumstances. By linking the carrier payment information with the pricing from providers within the invention, patients have unprecedented price transparency and can see exactly what they are responsible for paying before they get or use a service. For example, a patient has just been informed that he needs an orthopedic surgery appointment for follow up of a sprained wrist. Using the physician search function of the invention, the patient is able to search local orthopedic surgeons, see their office locations, view their credentials, schedule an appointment, see whether or not they are “in network”, and see how much the visit will cost. The patient can “click through” several choices of doctor and settle on the most convenient, cheapest, or use some other criterion. Because, in this aspect, the invention is cloud based, schedules, costs, and data are all in the cloud and are known in advance of need.

The InsuranceLink feature has several unusual advantages. The invention takes advantage of the alignment of interests between insurance carriers and patients, and utilizes it in new and unique ways. In this aspect, the invention optimizes the possibility that both carriers and patients want to save as much money as possible on health care costs. When the carrier saves money, the patient earns points (which can be turned in for money, or applied to premiums or services). This marketplace is mediated through the InsuranceLink function. For example, a male patient needs an elective total hip replacement procedure. His carrier has negotiated packages with Drs. Jones, and Wilson at his local hospital. The patient can have his procedure there, and pay the standard rates outlined in his plan. If he goes to a hospital 20 miles away (as offered by his carrier) and sees Drs. Johnson or Stevens, he gets 1000 “health points” in his account, which could be used for other goods or services, or cash back. He could also use some of those “health points” to see an out of network doctor for another problem sometime later. Health points could be accrued from his carrier or carriers by using preferred dialysis centers, ambulance providers, physical therapy centers, getting timely physical examinations, staying out of the emergency rooms, getting flu shots, keeping blood sugars in line, smoking cessation, diet and weight milestones, etc. In this aspect, the InsuranceLink provides the mechanism for a cash-back marketplace where patients can benefit from the money they save insurance carriers. It's time to get the patient's skin in the game, and the Invention-InsuranceLink is an ideal way to do it.

In one embodiment, on the provider tab, there is a list of the names, credentials, specialties, addresses, practice locations, and insurance affiliations of all registered physicians. This can assist patients in making informed decisions with respect to their doctors and, ultimately, to their potential out of pocket costs. If the carrier and the plan information are loaded into the invention, the patient can, before making an appointment, see exactly what an appointment, X-ray, or lab test will cost them in co-insurance or deductible. These costs are known to the provider in advance, and are known to the carrier in advance—the invention simply collates this information in real time based on the choices a patient clicks on. The patients can tailor their doctor/clinic choices and appointment schedules to their budget. The invention can subsequently keep track of these costs and subtract (and pay) them from their Health Savings Accounts, or submit them to their insurance using the InsuranceLink feature of the invention. The invention can also keep a running tab of all health-related expenses regardless of where they were incurred, and collates them for tax purposes.

In an additional embodiment, the invention has a feature by which a medical professional's credentials may be reviewed. In one exemplary implementation, this feature is called Credential-Link. This functionality is exceedingly useful for doctors, hospitals, CMS, and carriers. Whenever a new physician applies for privileges on a medical staff, the medical staff office must check his or her curriculum vitae against all entries since medical school and verify that the physician has been trained and has graduated from the programs on the resume. Every hospital must be verified, and each license hand verified. This process takes months, and has to be done every time a doctor changes facilities or adds a new place of practice. This cumbersome process has contributed mightily to the physician shortage in the United States, as many doctors are unwilling to go through the credentialing process in smaller hospitals. The Invention-Credentialink application of the invention solves this problem. By working with hospitals, training programs, and insurance carriers, this aspect of the invention can provide a repository of all information required by the credentialing process linked to fingerprint and iris data of each individual physician. These data can be stored in the physician profile of the invention and can be accessed by the carriers, and the hospitals on the network. Once the data has been verified, and linked with the biometric data, the credentialing process can take days rather than months, with much less expense. Doctors will be able to serve smaller hospitals faster, and will be able to verify information with insurers and the Centers for Medicare much more efficiently, with much less chance of fraud and abuse.

Insurance carriers can also utilize aspects of the invention to get a complete picture of which studies have been done, and more easily evaluate pre certification requests of patients according to specific guidelines. Evidence-based medicine can be more rigorously applied if all testing can be collated and organized into protocols and guidelines. Carriers can also use the physician registry function of the invention to highlight doctors who are “in network”, as opposed to those who are not contracted with their plan. This can save both patients and the carriers money. In this aspect, the invention can also, in a doctor's profile tab, list his or her appointment schedule. Consequently, a patient, using this aspect of the invention, can make his or her own appointment amongst multiple options using their computer or smart phone. A patient can choose between multiple doctors, either in or out of network, and choose the time and location (and out of pocket cost) that suits him or her best. The patient need only “link” to that doctor prior to the appointment, and all of his or her records are immediately available to that physician or clinic prior to the visit because they are on the invention network. The physician can be much more efficient and provide much better care if all of the old X-rays, procedures, and laboratory studies are at his or her fingertips. Carriers can also use the completed encounter form to aid in claims and billing for procedures and visits. This is particularly useful when two or more insurance carriers (e.g., major health and supplemental) are covering a bill or portions of a bill.

Third party modules (plug-ins) can be imported to patient, provider, and group screens on the network to increase functionality in all cases depending on the functionality desired and the constituency targeted.

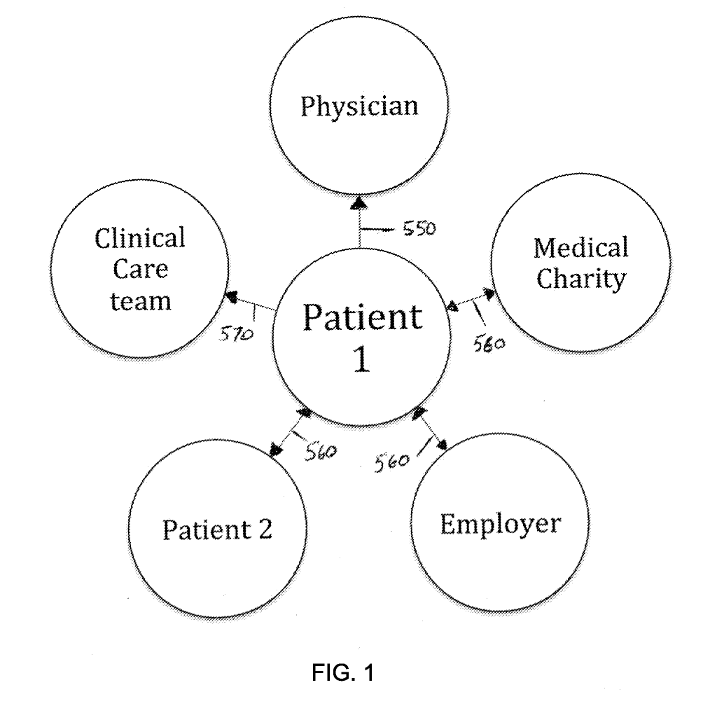

FIGS. 1-4 show, schematically, relationships within the social network feature of the technology.

FIG. 1 is an illustration of some possible connections of a user in the network, thereby emphasizing that a given user can be linked to many different other entities. The patient can be linked with a physician (550), or a group of several physicians such as a care team (570), in his or her network, as well as another patient, a medical charity, and the user's employer. Note that there is one-way communication on the network from patient to physician, or from patient to healthcare provider. Patients, charities, and other organizations are, however, free to “chat” or otherwise communicate back and forth with each other, or comment on posts from each other. Comments or patient-specific posts from provider to patient are not allowed because they could be construed as a medico-legal communication that cannot be altered. In the principal embodiment of the network, communication of specific patient data between patients and clinical staff is unidirectional. That is, from patient to physician or other provider (550). In its principal embodiment, the network is not designed to be an “official” medical record. Bidirectional communication (560) is easily accomplished, for example, between patients, non-clinical organizations, medical charities or appliance manufacturers, and employers. All of these entities can post notices, post reports, “like” postings, and comment on postings, comparably to activities on other social networks. All comments, “likes”, and postings from a linked user will appear on the update feeds of all users linked to that user as they are posted.

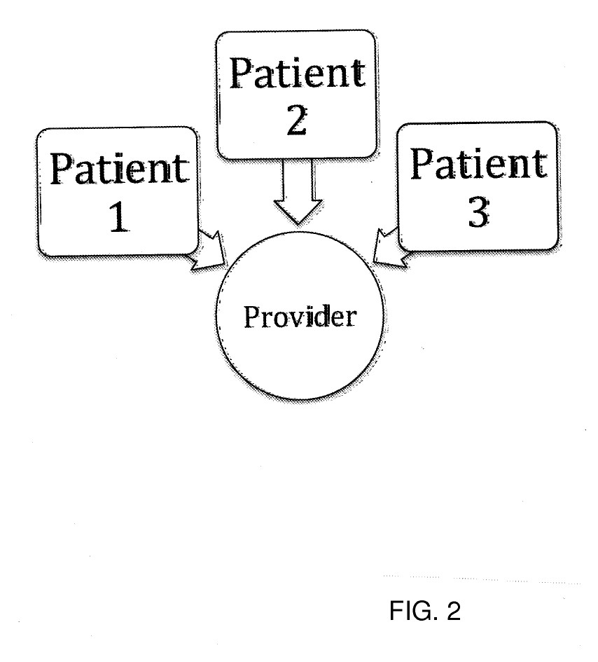

FIG. 2 demonstrates how multiple patients can be linked to a single provider. In many cases, a primary care provider has thousands of patients. Realistic or not, patients often assume that their doctor knows (or should know) if they are admitted to the hospital or have seen a specialist, even when that specialist is in another facility or even in another state. If the patient posts their health activity on the network, and their primary care physician is linked, the patient's activity pops up on their doctor's update screen. By logging into the network before the daily rounds, or before the office opens, a physician can get a quick update of all linked patient activity locally, or around the world. This can be useful when monitoring trends in, e.g., the spread of a viral infection.

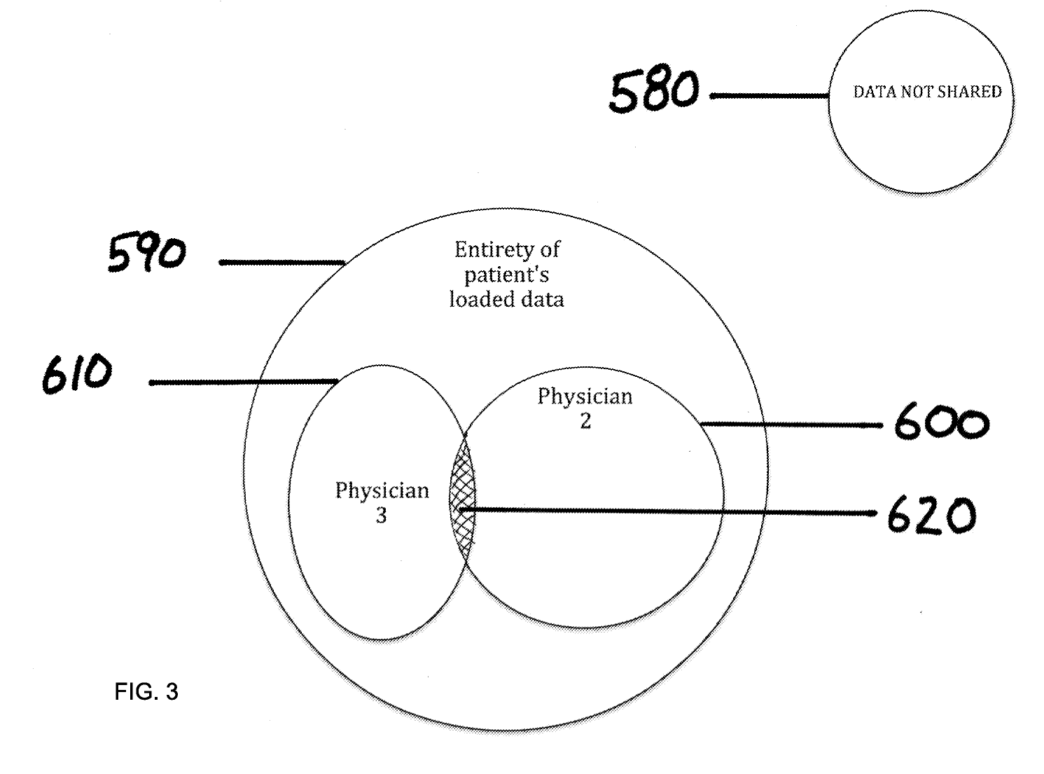

FIG. 3 is a Venn diagram of an example of patient data sharing. Note that there is a portion of the patient's data, which, although it is in the patient's complete legal medical record, the patient has chosen not to load on the network. The patient has chosen to share subsets of his/her data with each of two different physicians, and only small set of the same data shared with both. Patients who load some of their medical data onto the network can still choose to leave some data off of the network entirely (580). Within the data that a patient chooses to load (590), subsets of that data can be shared with different users. For example, much of the data shared with Physician 2 (600) is different than the data shared with Physician 3 (610). The data that is shared with both providers is shown as the shaded intersection between the two circles (620). Note that, for the subset of data that is not even on the network (580) to be accessed by anyone else, the patient would either have to load it onto the network, or access it from the primary medical record kept at the applicable treating facility.

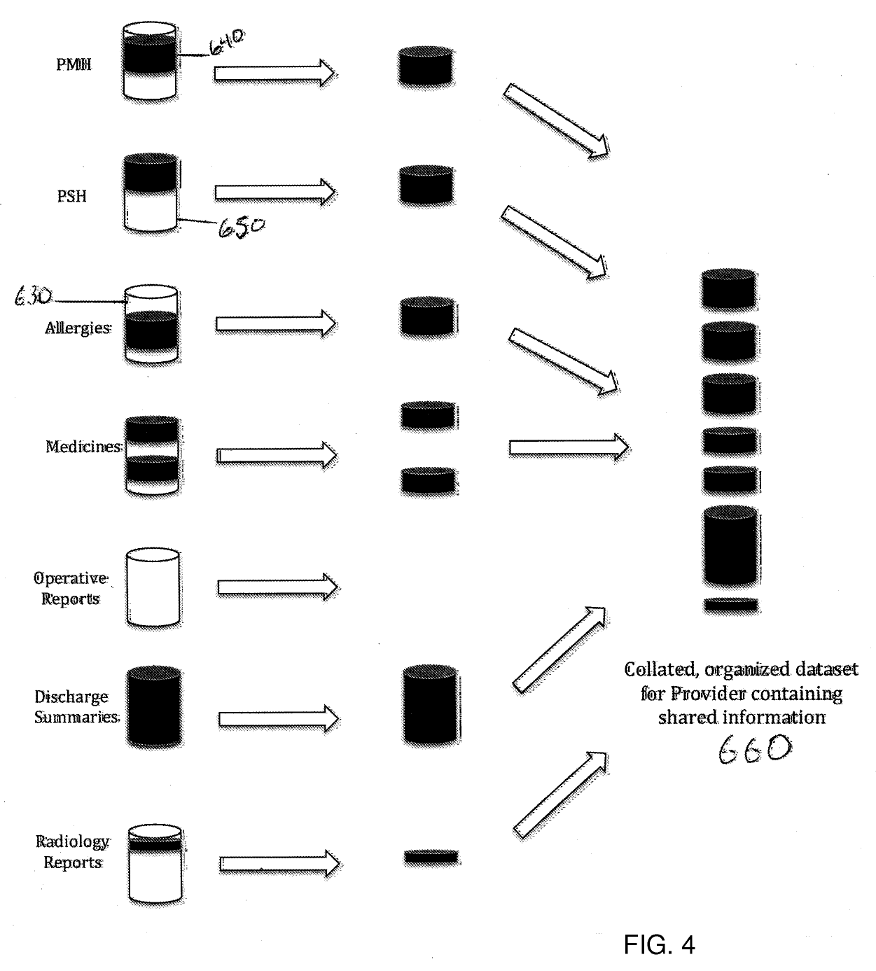

FIG. 4 demonstrates an example of how shared data can be collated and organized from the patient's share permissions on the user page onto a provider's page. Note that the patient-selected subsets of each medical record section are collated into a unique dataset presented to the provider with whom the patient has “linked”. In this example, sections of the network have been labeled with the fields typical of a medical record. The whole EMR section is depicted by the large barrel (630). The subset that the user wishes to share is dark (640), and the portion of the section that the patient does not wish to share is white (650). The shared portions are extracted into a buffer, and are collated into a readable whole for the provider (660).

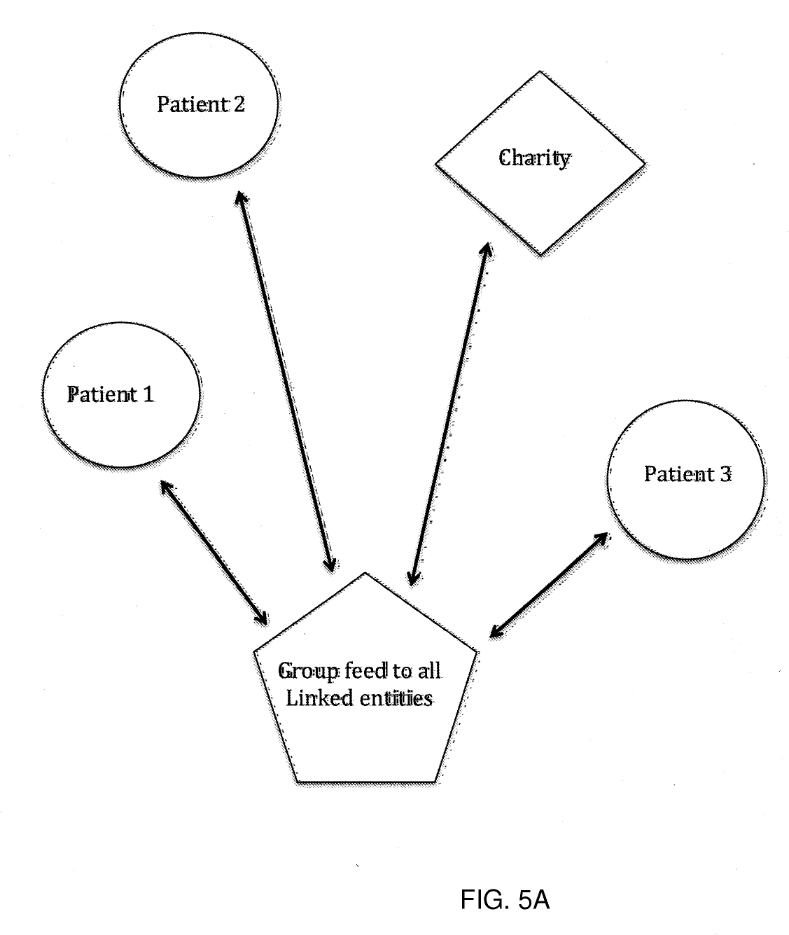

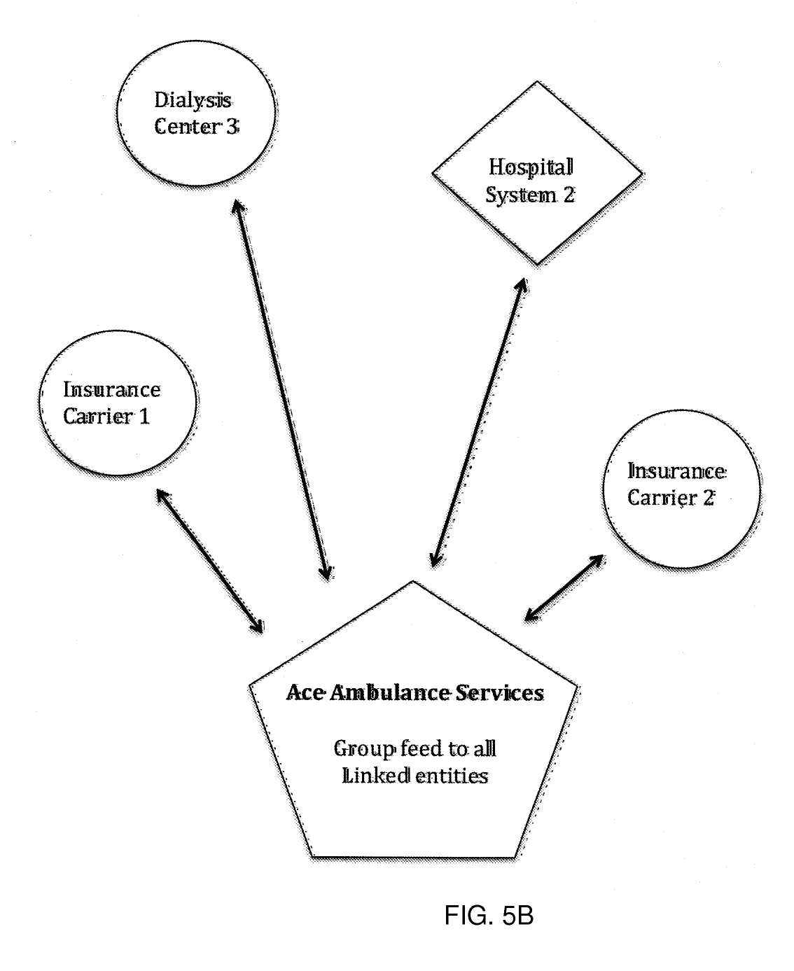

FIG. 5A represents an example of how information can move in a group chat on the network. As shown, three patients and a medical charity are members of a group on the network. In this example, the charity has started the group, and the three patients are group members. All posted activity can be seen on the group page, and all members can comment, “like”, or otherwise interact with the posting. The charity's medical officer, or other representative can hold a webcast, post a podcast, or moderate a discussion. Because the charity is not a health care provider, two-way discourse is allowed. Patients can comment on charity posts, and upon posts of other members. As in other social networks, the entire group correspondence can be seen by all linked entities. Patients can post information or ask GENERAL questions about the topic or field. Specific, patient-centered advice or recommendations to a specific patient from licensed professionals is, in the principal embodiment, not permitted.

FIG. 5B illustrates how supply, demand, and price information can move in a group chat on the invention's network. In this example, two insurance carriers, a hospital system, and a dialysis center are all bidding for ambulance services provided by “Ace Ambulance Services”. In one scenario, Ace could post a schedule on the group, and the entities could bid for slots—with the more desirable slots presumably costing more. In another scenario, Ace could post rental “days” and the entities could rent the service per vehicle per day. The possibilities are limitless, and can apply to virtually any good or service for which there is a supply and demand. Third-party modules (plug-ins) can easily be employed to facilitate the market-making functionality, using “bid-asked”, or eBay-like bidding protocols.

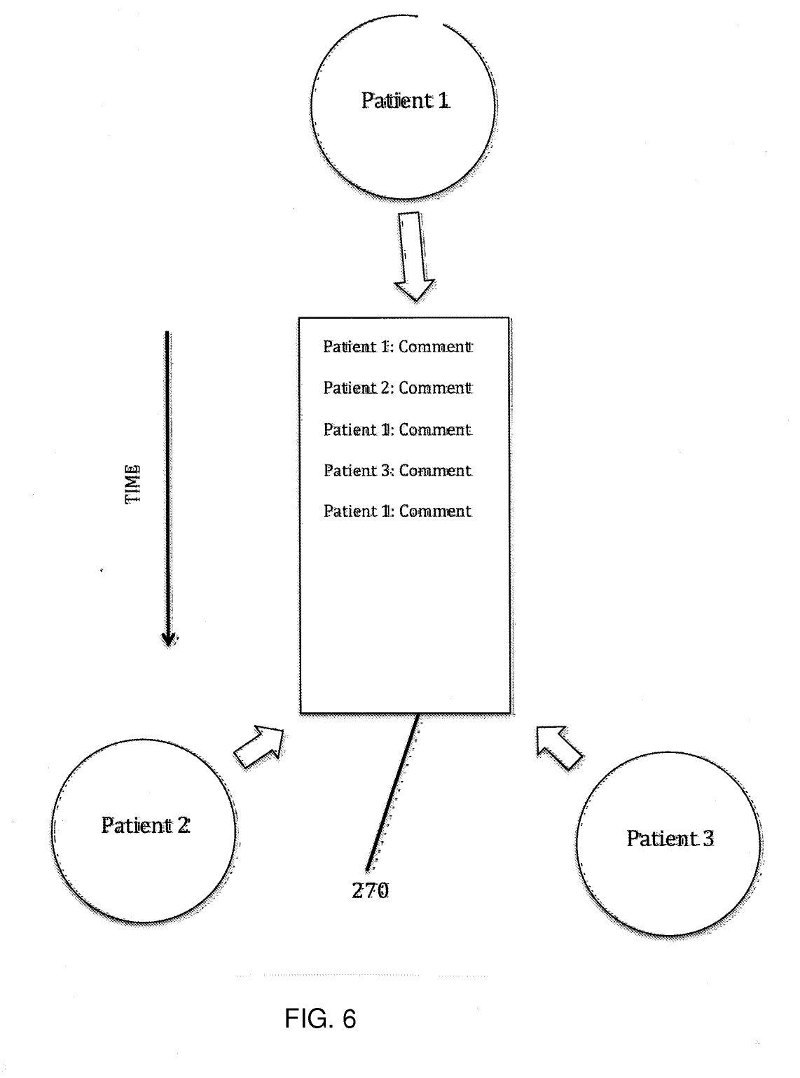

FIG. 6 demonstrates how the network can facilitate a patient support group, without a linked licensed professional. The discussion would proceed on the update feed of each participant. Patients are free to discuss a topic, make postings, “like” postings or otherwise interact in ways typical of other social networks. The update feed over time is shown (270).

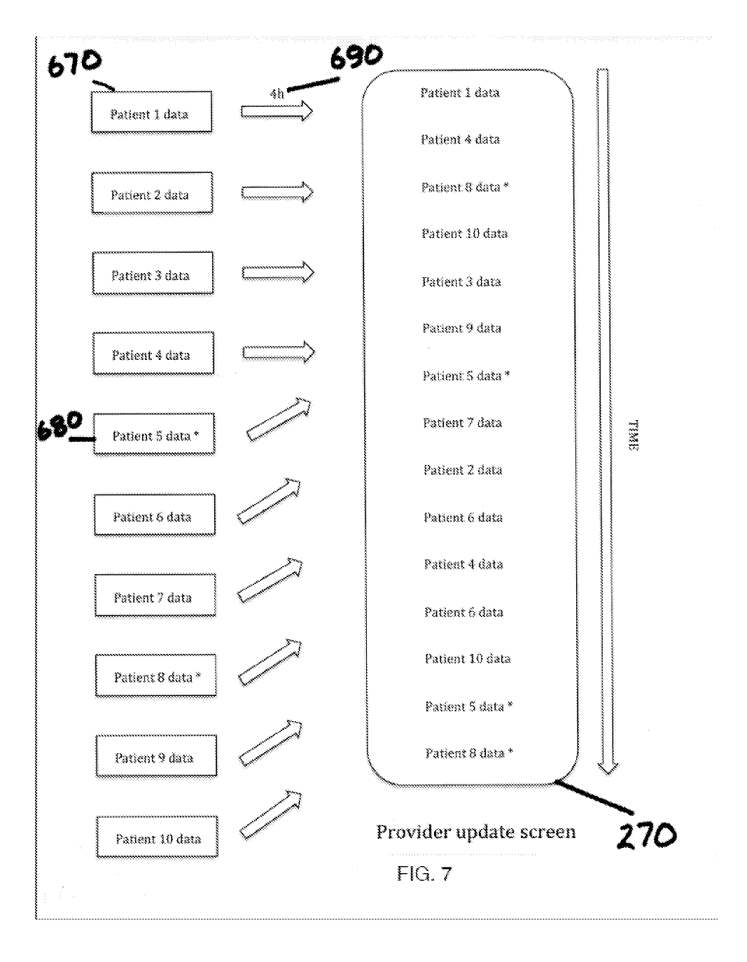

FIG. 7 illustrates how the network can be used by health care providers to monitor patients who are at home or who have been discharged from the hospital. In this example, ten patients have been discharged from the hospital. All patients have been loaned an electronic monitoring device by the hospital for use in the post-discharge period, and have linked with the post discharge nurse. The patients have been asked to post data on their network page every four hours. All such data, when posted, will pop up on the nurses' feed as they are posted. Patient 1 (670), for example, is doing well whereas Patient 5 (680) is not. The nurse can follow up with the patients not doing well, and can intervene when needed. The network makes this process efficient, because a single nurse can monitor many patients and only follow up, or follow up more frequently, with those who need it. Note that in this example patients submit their health data onto the network at defined intervals. Once submitted, all of the data shows up on the provider update screen. The provider can then analyze the data and act on any abnormal findings.

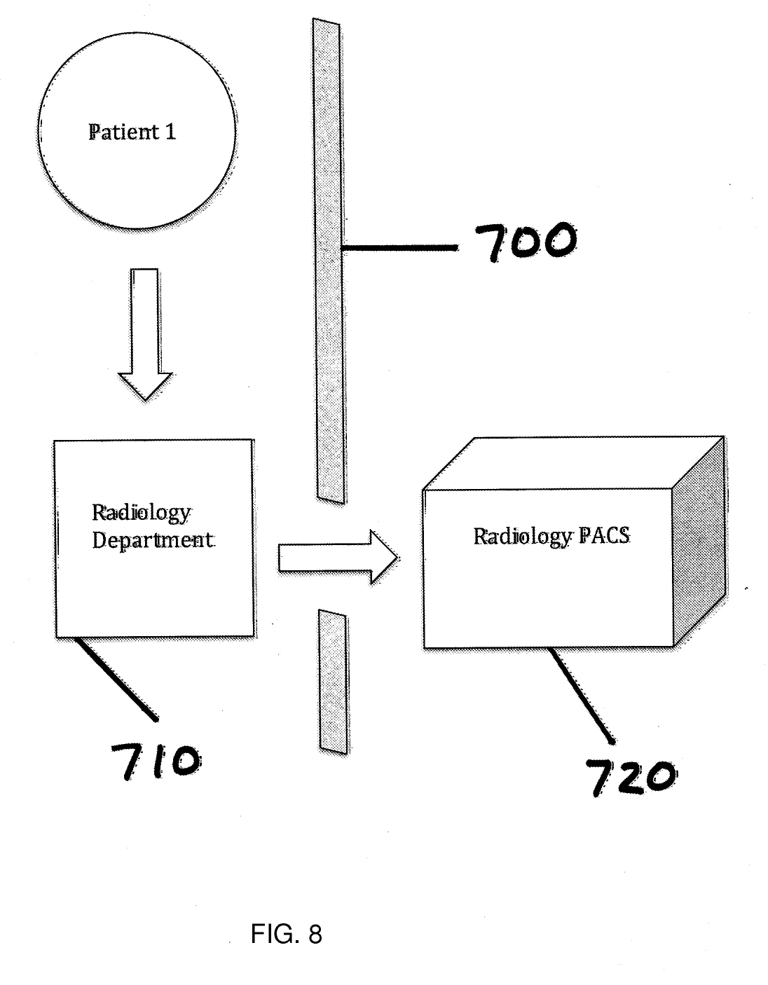

FIG. 8 represents how the network can be used to compare radiographs from one facility on the PACS of another facility (720). In this example, the patient needs to link with the radiology department (710) on the network. Once linked, radiographs stored on the network can be pulled up on a PACS browser window that contains the relevant network page, and be compared. In the principal embodiment, radiographs on the network are not archived or stored on the PACS. They can only be accessed for the time allotted by the user, and only the images that the patient wishes to share can be seen. The HIPAA wall (700) is illustrated to emphasize that, for images to be stored on the PACS and off of the network (720), there must be permission from the patient and HIPAA compliance. In this case (as shown with the arrow), the radiology department can load the images on their PACS using standard transfer protocols. In this aspect, the invention contained images need not be transferred onto the hospital PACS. A side-by-side unlinked computer set up is sufficient.

Of course, a non-PACS networked computer screen or screens can be pulled up alongside of the department PACS screens to compare images directly from the Life-Link Network with those on the PACS screen without integration into the hospital PACS.

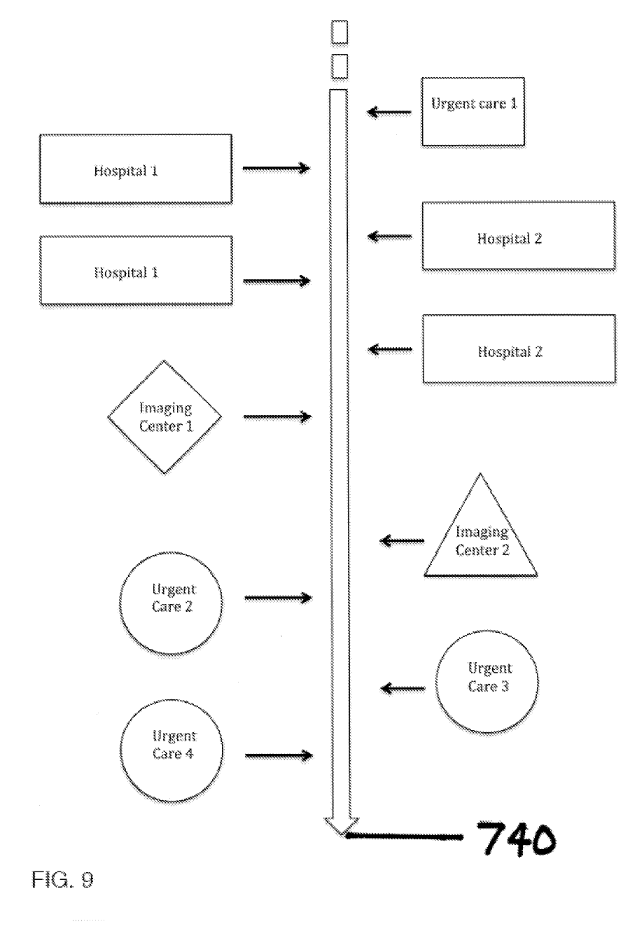

FIG. 9 demonstrates how the network can be used to generate a longitudinal medical record. In this example, the patient has visited multiple facilities for care, and linked with all of them on the network. The network collates the loaded encounters by date of service, and can print a summary of all loaded and shared patient encounters. If the patient does not choose to share an encounter, either it could not be loaded, or a box next to the encounter indicating “share” could be left unchecked.

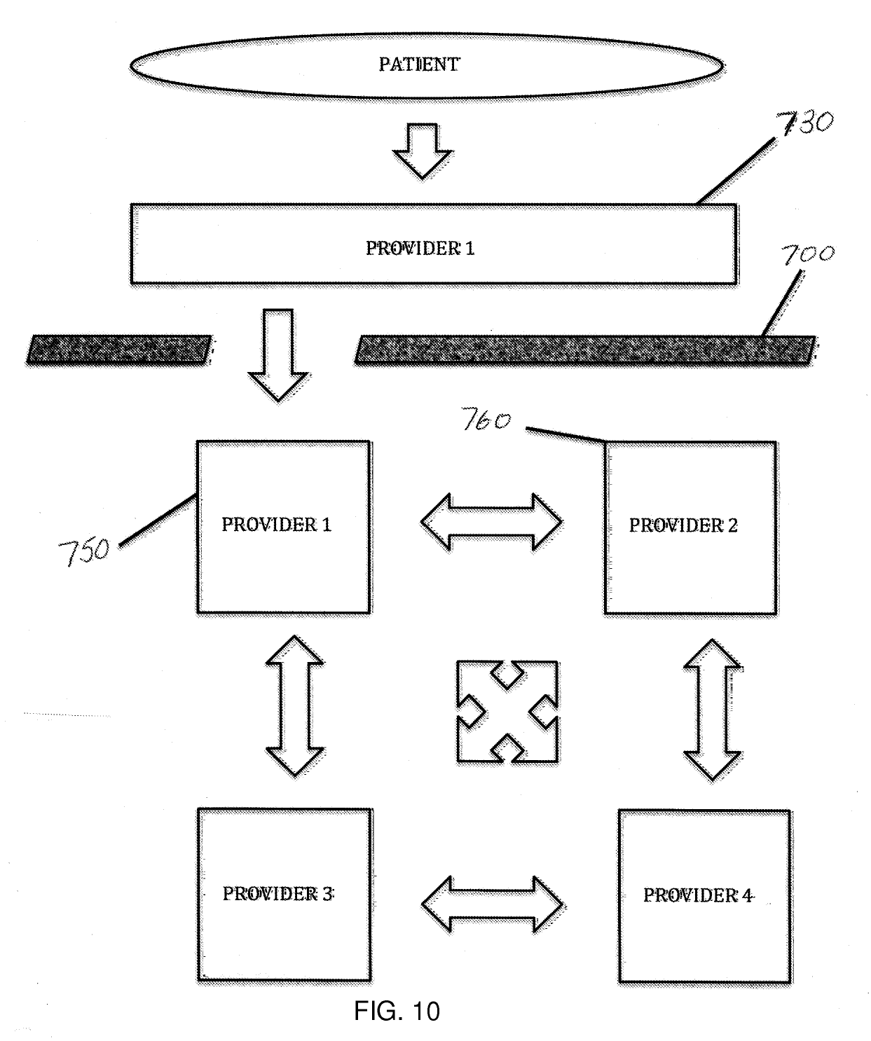

FIG. 10 demonstrates an additional embodiment by which the patient has given provider 1 (730) permission to download and share his or her data in a HIPAA compliant environment. The HIPAA firewall is shown (700) for orientation. In this example, Provider 1 downloads the patient data into his HIPAA compliant Provider layer (750) and, by following HIPAA protocol, is free to move the patient's data electronically between providers and comment on the data with a colleague (760) or colleagues. This functionality is particularly helpful when conducting interdisciplinary conferences, or care group reviews such as cancer care team meetings, or radiological-pathological conferences. Also provided are secure, HIPAA compliant group and individual messaging between providers.

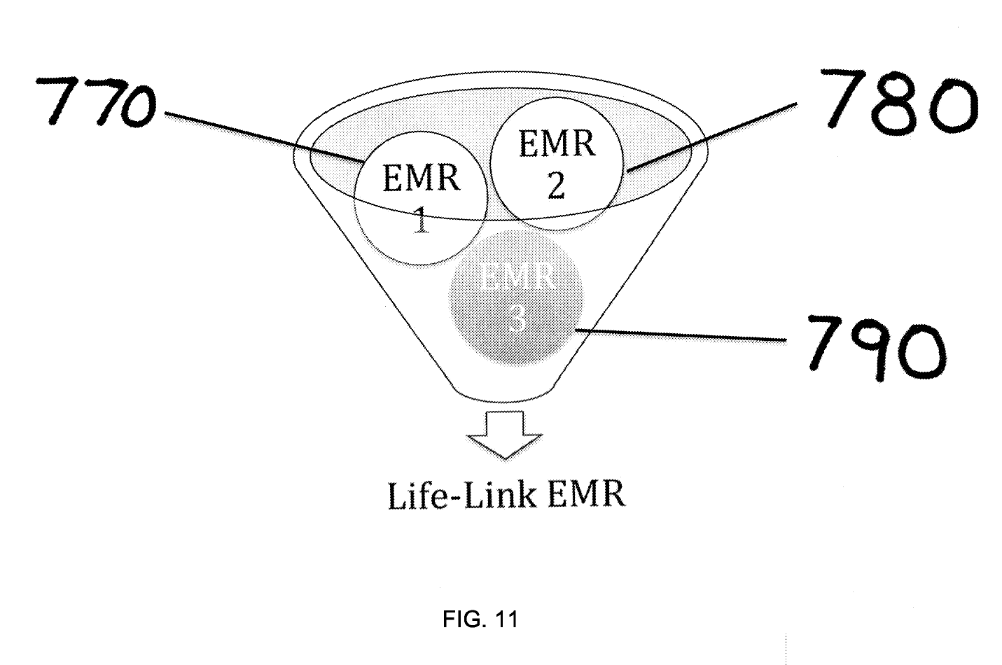

FIG. 11 is a schematic demonstrating the network's EMRlink functionality. In this example, selected sections of electronic medical records from different manufacturers, Vendor EMR 1 (770), Vendor EMR 2 (780), Vendor EMR 3 (790), are copied and collated by time into a single “Networked EMR”. This can be accomplished in a non-HIPAA or HIPAA compliant environment, depending on user or need. The networked EMR is not an official EMR because some sections may not be included in the record. The ability to streamline a copy of the EMR is extremely useful, because official medical charts contain every blood pressure measurement taken, and every progress note. The official records can be very cumbersome in practice, and important information or data are often lost in a sea of “electronic paperwork”. The Networked-EMRlink allows the important and immediately useful sections of the record to be available for clinicians when they need it.

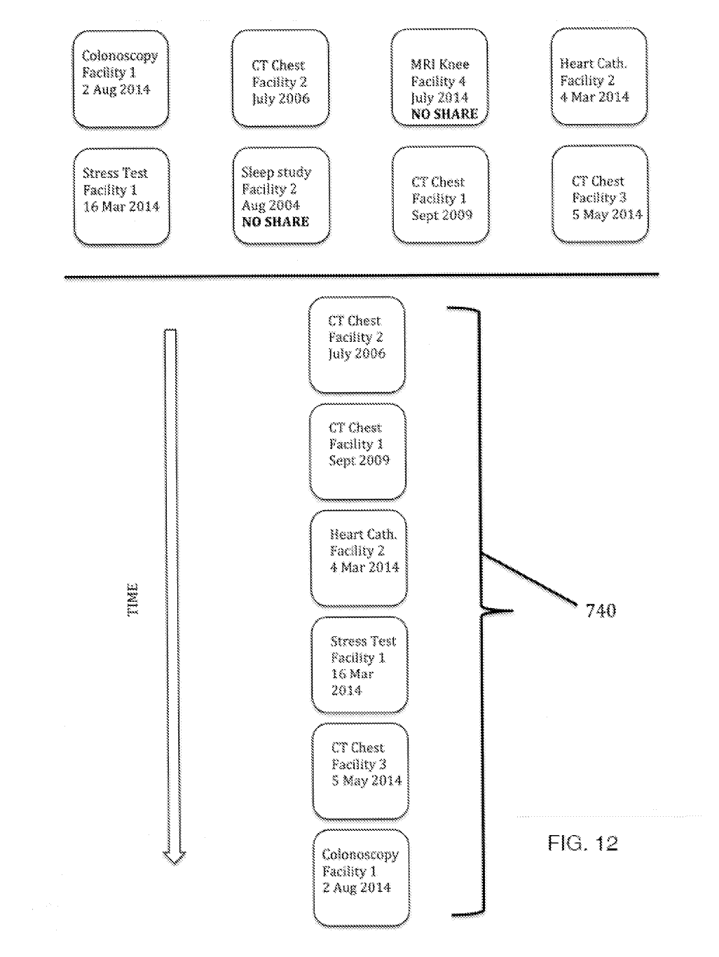

FIG. 12 illustrates an example of how a patient might use the network to fashion his or her own longitudinal health record using data loaded onto the network. In this instance, the patient has chosen to share only some of his diagnostic tests from different facilities. The network can be used to organize the studies and their reports by date into a manageable report (740) for a provider.

### Additional Features and Benefits of the Network

By accessing the network, a patient can eliminate the need to repeat medical tests that were done in another healthcare facility, because the new treating facility can access the old results quickly and securely. For example, blood tests obtained at a suburban diagnostic laboratory in the week prior to surgery or a CT scan can be accessed by the main city hospital or surgical center over the network (rather than be repeated) on the day of the procedure.

Aspects of the invention can also be used to access stored medical records such as an old ECG, while a patient is still being evaluated in a new emergency room or other acute setting, e.g., on an airplane or cruise ship. The ability of the new doctors to view the old ECG and compare it with the new one can often avoid (or downgrade the severity of) a hospital admission. If a patient has a chest pain on an airplane, the ability to access an old ECG could potentially prevent the pilots from having to make an emergency landing, for example in inclement weather or in another situation that might otherwise put all of the passengers at risk. Similarly, using the network to access an old chest X-ray can save a physician from having to admit a patient for “acute pneumonia” when a previous radiograph demonstrates the lung findings to be old.

When using aspects of the invention to access old radiographic studies and compare them with new ones, the repetition of radiological tests in the form of “follow-up” examinations can also be streamlined. Once an old examination demonstrates that a recent finding is chronic or has not changed, the need for “close interval follow up”, or another procedure such as biopsy of a lesion, can be eliminated. Since radiographic lesions in the lung are often followed every six months for two years, a large number of unnecessary scans can be avoided. Furthermore, lung biopsies are inherently risky, and when one goes bad, often a patient must be admitted or have surgery. This is simply bad medicine, particularly if the biopsy could have been avoided completely.

The network can also be used to confirm the identity of a previously placed surgical implant. The ability of a patient to obtain an MRI often depends on the patient not having a certain kind of medical implant. Certain types of implants, e.g., aneurysm clips, are not “MRI safe” because a patient who has one cannot safely be placed in the magnet. If a patient cannot document what kind of clip they have, then the MRI cannot be performed. When a patient receives a surgical implant of any kind, he or she is given paperwork and an identity card. Patients are supposed to carry these cards with them at all times, but rarely do. The network, however, can store in the cloud a photograph or scan of the aneurysm clip card and the paperwork. The MRI facility simply needs to be given permission to access this information by the patient, and the MRI staff can confirm whether the scan can take place. This confirmation of MRI suitability can be done before a patent even leaves home or work for the facility, and, if the study needs be cancelled, no travel time or facility time is wasted.

The network can also serve as an access point to a repository of medical records from the same, or different, facilities. Once a patient has been admitted to a hospital, there often arises a scramble to obtain the records from prior visits. Usually, if a patient has a prior admission to the same hospital within a year, the records are on site. However, if the admission is over a year old, the records are often stored “off site” and may take days to be located and retrieved. The network, having stored the records from the previous encounters, is perfectly suited for this purpose. Regardless of their origin, the network can easily provide current physicians, technologists, and nursing staff access to the data they need. Because there is significant pressure on hospitals to discharge patients quickly, procedures, consultations, and radiographic studies are often repeated rather than having to wait for the old results. If, however, a patient has been admitted to a different hospital, getting the old records and results is so cumbersome as to be virtually impossible. In this case (which is increasingly common with patients changing doctors and insurance carriers so often), procedures are almost always repeated, regardless of when they were performed.

The inability of a provider to get medical records in a timely fashion costs a great deal of money and wasted time. For example, patients often present to the emergency department with abdominal pain. Since they are in pain, patients can't always remember what tests or procedures they may have had in the past. Because many surgeries are now scarless, the examining physician can't always discern what the history is from assessing physical signs alone. Consequently, patients are very commonly held in the hospital overnight waiting for, say, a gallbladder ultrasound, only for the provider to learn that the patient has had his/her gallbladder out years before. By linking with a patient using this network, the physician and the patient could have saved both an ultrasound and potentially, a hospital admission. The easy availability of the network, therefore, can reduce, or even eliminate the need for these admissions, duplicate tests and procedures, saving time, money, and additional risk to a patient.

Because there is such pressure to release patients rapidly from the hospital, sometimes the discharge happens before the patient is ready. Occasionally, the patient returns to the hospital sick and needs readmission. Readmission is very expensive. Often the hospital has to foot the bill for the entire readmit stay, and lately, Medicare has also imposed a fine to further penalize hospitals. Aspects of the Invention provide methods for easy monitoring of a patient while at home. A patient need only to permit continuous monitoring of his data by the home-care team, and the patient's vital signs will pop up on the provider's page as soon as they are posted. The patient, a caregiver, or an electronic monitor need only upload data to the network, and it will be available for the care team at the hospital to see. The team nurse can monitor the update panels of numerous post-discharge patients, and only have to call and follow up with the ones whose vital signs show up on his or her update panel as being of concern.

As a social network, patients will also be able to “link” with organizations such as cancer societies or support groups and will be able to broadcast their thoughts, or even health data, to the group, if so desired. Patients can also link with their insurance provider to receive, for example, notices, or special offers relating to their health, or ways to reduce their premiums. A patient need not share any health information with these organizations to be a part of a group. He or she simply needs to “link” with the organization or group (and share “none” of their data), and the organization or group's posts will appear on the patient update panel.

Groups are easily formed on the network, either by individual users or organizations, by “forming a group” on their home page. By doing so, other patients are free to link with the group. Patients are also free to “link” with other patients. Aspects of the Invention also provide the ability for patients to have their health parameters monitored remotely by providers who have been given permission by the patient. Providers can monitor a group of patients who have all linked and have given permission to view their real-time update panel.

In the principal embodiment, data can be added to data fields by the patient only, or downloaded electronically by the patient. In the principal embodiment, providers and linked groups can broadcast information to their linked patients, but not add data specific to a given patient. If the patient gives permission, the network also provides for downloading data stored in the network to populate medical records, or incorporate data electronically from a treating facility.

If a patient gives permission and links with, for example, a radiology department account, old images obtained from the network (regardless of where they were generated) can be loaded on their PACS and placed adjacent to the new ones for direct comparison. Images taken and loaded from microscope slides can be shared and read in similar fashion.

In the principal embodiment, patient data can be entered into the database by the patient (or by his/her designated representative), either by filling out a checklist, by downloading from a portal site of a diagnostic or treating venue, or directly from materials provided to the patient at the time of testing or thereafter. In an additional embodiment, data can be transferred to the network electronically from its point of generation. A direct upload to the network by the patient from their provider's Electronic Medical Record (EMR), or from a CD containing EMR data can also be accomplished. In the principal embodiment, notes are not to be entered directly into the database in real time by physicians or other healthcare providers; however copies of notes and data from a previous encounter can be uploaded to the network by the patient if desired, and deleted later if the patient so chooses. The database of the principal embodiment is not designed to be a legal record of a healthcare provider activity; rather its role is simply to deliver old records and data from a previous treating facility to the new facility rapidly and securely. Consequently, because the network, in its principal embodiment, is not meant to serve as the complete, official medical record, patients are free to add, delete, or modify all information contained within.

Access to the network does not depend on the timeliness or immediate cooperation of the hospital, clinic, or physician's office that generated the original data because that data has been requested and stored previously in the network. This information can include, but is not limited to: Past medical history, current medications, allergies, past surgical history, radiographic studies, electrocardiograms, and laboratory studies. Additional data such as radiology reports, pathology reports, clinic notes, procedure reports, specialist consultations, hospital discharge summaries and health monitoring data from an external device can also be stored and retrieved at a moment's notice by either a patient or his/her provider depending on the permission (level of access) given by the patient.

A patient account, which is in a non-HIPAA compliant environment, has the ability for a patient or other entity to subscribe to the “Premium” monthly service individually via a payment service, or to choose from a list of entities, e.g., insurance providers or large corporations that will sponsor their account. A “free” account function could be available where advertisements are shown to patients, in lieu of a cash payment. This ad-functionality can be later “turned off” if the patient becomes a “Premium” member either by, e.g., PayPal payment or through payment from their insurance plan or corporation. Patients are allowed to share any or all of their data with a given provider, or with whomever he/she is linked. The patient “home page” of the network gives the patient the opportunity to pick which of his/her loaded data to share with each provider, and for how long. When the patient is linked to a provider, any new data available to the linked physician will come up on the provider's update panel. Organizations, e.g., charities, medical device companies, pharmaceutical manufacturers, or employers, can also have a non-HIPAA user account such that they can reach and share information with the patients who have linked with them.

The provider account, in the principal embodiment, is a non-HIPAA compliant layer unique for each individual doctor or healthcare provider; or facility, for example, “St. Barnabas Hospital Emergency Department”. For each account, there is a list of “linked” patients, and their time to permission expiry. The provider account has additional fields that list the doctors or other providers signed onto the account, and the list of patients who have “linked” the account. There is a “print” function to allow providers to add a hard copy of the shared contents (printed record) to the official medical record, if desired. In an additional embodiment, ICD codes can be appended to remote or second opinion evaluation requests and used to code and bill for remote evaluations of patients using, for example, photos and video. In an additional embodiment, if a HIPAA release is signed by the patient that allows upload of records to the network, any provider can upload a copy of their notes, data, or diagnostic results directly to the patient's record on the network. Since it is a copy, the patient can delete these records if he/she wishes.

In one aspect, there are separate accounts for patients and for health care providers. Both patients and providers should agree to the product's “Terms and Conditions”. Both patient and provider accounts have functionality for advertisements (that can be turned on and off).

In another aspect, there is an “Admin” function where fields or entities within fields of the form can be edited or added. There is a “mobile banking” level of security with multistep and two-device authentication.

In the principal embodiment, patient fields typically comprise the following:
1. Demographic info (e.g., from a keypad. Using an alias is OK)
   a. “User Name”
   b. Date Of Birth
   c. E-mail address
   d. Cellular telephone number
   e. Home phone number (if any)
   f. Gender
   g. Age
   h. Primary physician name and address
   i. Primary hospital name and address
   j. Medical insurance info
   k. Emergency contact
   l. Medical Power of Attorney
   m. Medical Power of Attorney contact info
2. Past Medical History
3. Current Medicines
4. Allergies
5. Past Surgical History
6. Implanted devices, clips, ports, or joint replacements
7. ECG, insurance and medical device cards (for example, input to the patient's page from a camera, USB, email, text message, scanner, or fax)
8. Radiographs (for example, extracted from a CD ROM, USB, or electronically).
9. Laboratory data (for example, input to the patient's page from a camera, email, text message, scanner, or fax).
10. Other medical record information, e.g., Biometric data, Hospital Discharge summaries, Radiology reports, Pathology reports, Clinic notes, Powers of attorney, living wills, Procedure reports, Specialist consultations, Hospital Discharge summaries, or Health monitoring data. All of these can be entered, for example, by input to the patient's page from a camera, USB, email, text message, scanner, or fax.

Items 2-6, past medical history, allergies, past surgical history, and current medicines can be entered into the database, for example, by sequential choosing of items on a “choice wheel” on a mobile device or “drop-down menu” or checklist. Access to a list of medical implants is also provided in another aspect. These implants include, but are not limited to heart defibrillator, artificial joint, pacemaker, breast implants, spinal screws/disks, IUDs, ear tubes, artificial eye lens, chest port, heart or other vascular stent, vena cava filter, picc line, drainage catheter, dialysis fistula, dialysis catheter (permcath), aneurysm clip, metal in eye, and brain shunt.

Electrocardiograms can be entered into the database by taking a photo of the sheet or strip, and then sending it to the program, using drag and drop, email, messaging, Bluetooth, or other service. Entering a CD provided by an imaging facility or other diagnostic venue into a drive on a laptop or desktop computer, and transferring the image files to the database is easily accomplished. Photographs of lab data, surgical or radiological-placed implant cards, and of an ECG sheet or strip can also be entered and stored using PICT, JPEG, or other picture file format. Either direct or wireless transmission by, for example Bluetooth, between a monitoring device, (e.g., telemetry box, iWatch, or blood analytic apparatus), and the database program can also be accomplished using existing wireless technology or via USB connection. Additionally, real time data can be transmitted to caregivers who are monitoring the patient's update panel using the network update feed. For example, a nurse monitoring a post-discharge patient who is at home, can know rapidly and securely when the patient's vital signs are outside of the normal range and then can initiate further care, simply by monitoring the data update panel from patient to caregiver. Information can also be loaded into the network directly by a patient from e-mails or text messages from providers, or from third party sources, e.g., Apple Health Kit, or contents from the Internet.

Each patient's dataset is stored securely in a “cloud” server and patient access to their respective data can be attained either by a mobile application or a desktop application. If the provider chooses to print or download the data, HIPAA regulations will apply to data obtained if stored off of the network. In this way, the patient (or his/her designated representative), can access the data or provide access to the data as many times as they wish, can provide access permission of some or all of the data to providers, in a fast secure way without compromising privacy and without having to remember to bring old films, medication lists, device implant cards, or other data with them. There need be no calls or visits to prior facilities, forms to fill out, documents to notarize, etc. Data can be accessed and sent easily from the patent to providers wherever they are in the world, as long as the person(s) have web access and have been given permission by the patient.

In the principal embodiment, physicians or other caregivers are not permitted to comment upon or otherwise communicate in a specific manner with patients on the network. Sometimes, however, physicians or other members of the care team may wish to communicate with each other to provide the best care for all of their patients. Although physicians and caregivers are not permitted to discourse with the patient on the Invention about specific medical problems (so as to avoid data on the Invention from becoming a legal record), in further embodiments, there is provided a secure HIPAA-compliant layer in combination with the principal embodiment that can be used to share a patient's medical information if, and only if, permission to share it has been given by the patient. In this embodiment, a HIPAA compliant layer can be added to the principal embodiment to permit sharing of medical records and or other information directly between physicians or other care providers. The patient need only give permission for their network data to be downloaded into a HIPAA compliant layer. If the patient grants permission electronically (for example, by checking a box on their home page), the linked physician need only press the “download” button on the screen to move the patient's information to the HIPAA-compliant layer. This layer, when added to the principal embodiment, will allow a patient's information to be shared in a compliant manner such that the information can follow the patient from appointment to appointment at the same provider, or facility to facility, wherever he or she goes in the care path.

In this embodiment, copies of patient selected sections of the patient's full EMR can travel with a patient in a HIPAA-controlled protocol. Patients will still have ultimate control of any and all data shared on the network. The HIPAA-compliant Provider layer of the network is not the same as the provider layer of the principal embodiment, which is not HIPAA compliant, but is linked to it with a second layer of authentication. The network's Provider layer, although it communicates with the provider layer of the principal embodiment, moves a patient's data into a HIPAA-compliant environment so it can be legally shared between providers. This movement from non-HIPAA to HIPAA layer is significant, because in the HIPAA-compliant layer, physicians and nurses can share the patient's data and images between themselves, and can discuss treatment options, or present them in a patient care conference. The network's Provider can also be used in electronic patient scheduling so that the patient's “Network-EMR” follows the patient from appointment to appointment. Caregivers can also use the messaging function of this layer to communicate between themselves in a HIPAA-compliant environment. In an additional embodiment, using, for example, Network's-Provider, a HIPAA-compliant layer of the network, Physicians are able to link across town or across the world to coordinate care, plan care conferences, or simply discuss developments in their specialty using HIPAA-compliant functionality.

Because sharing data between EMR vendors is virtually impossible, in a further embodiment, there is provided a bridge program, the network's-EMRlink, by which a copy of some or all data from one manufacturer's EMR is sorted and collated into a file, and other EMR data (e.g., from a different facility or manufacturer), is also added, stored and sorted into Invention's-EMRlink. Selected data from each EMR is uploaded and sorted into the standard fields of the network, and arranged by date of service. The selective data incorporation is important, because, for example, patients and other providers might not need or want to see records of, say, the four or more blood pressure measurements that were taken on a hospitalization several years previously. Once all of the desired data is sorted and stored, a composite “Network's EMR” can be compiled and given to a patient or, if permission given, to a provider. This “Network's EMR” will have patient activity listed along a timeline, regardless of which facility created the data. Since patients don't care where care was provided (but care a great deal what care was provided), having this longitudinal record will assist patients and providers in knowing exactly what was done, where, and when to a given patient.

### Exemplary Interface

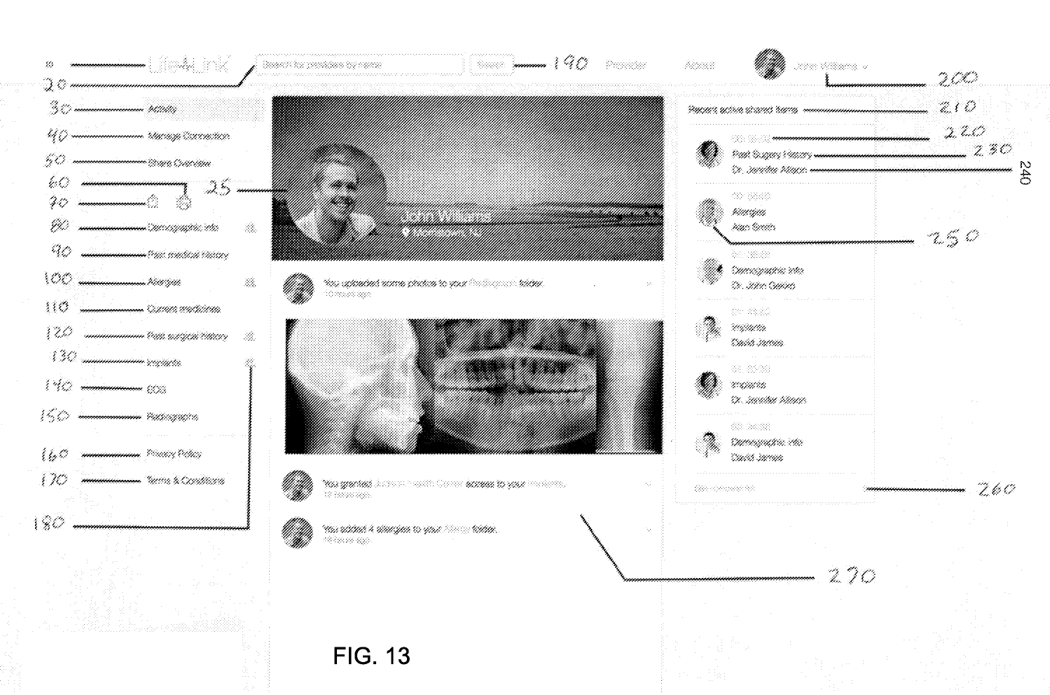

FIGS. 13-21, show an exemplary embodiment of a computer software product that implements the network technology of the present invention. It would be understood to one of skill in the art that the layout and arrangement of the features in the screenshots of FIGS. 13-21 is immaterial to the underlying functions and manner of operation of the invention. Thus, the use of tabs, buttons, and other forms of link to organize the data and its interconnectivity is exemplary in the drawings as shown, and other permutations or arrangements of those features could be used in other implementations that provide comparable functionality.

FIG. 13 represents a patient's home page in an exemplary embodiment of the invention. The patient (also referred to herein as the user) is reminded that he or she is in the environment of the invention by a logo (10) associated with the technology. An example of such a logo is for LifeLink™. Across the top of the page, the patient finds a search bar (20) and button (190) to initiate a search. This search bar and button can search the entirety of the network for providers, patients, organizations, hospitals or clinics with whom the patient can link. The profile picture (25) of the active user is shown centrally, in the upper panel. On the left of the home page is a representative list of fields 20-50 and 80-170 contained within the patient record, buttons 180 to manage and share patient data, and controls (such as further buttons 60, 70) to print or electronically transfer the entire record. Clicking the Activity tab (30) will bring the user back to their home page on the network, as will clicking the Identity tab (200) on the upper right of the page. The user can manage their linked connections, and add or remove their linked entities by clicking the Manage Connections tab (40). This tab brings the user to a page where all links are listed and the user can add or delete their linked entities. The user can share medical data and see those with whom they have shared it by clicking Share Overview tab (50) on the left. The profile can be printed with selected contents using the print button (60), or sent electronically to a linked recipient using the export tab (70). By clicking the Demographic Info tab (80), the patient can enter, view, update or edit their demographic information. Initial filling of the demographics occurs on registration; but new data, e.g., a new primary pharmacy, or updated information, e.g., a new primary care physician, can easily be input.

The patient can, depending on their subscription type, use an alias name so that their identity can be harder to ascertain by third parties or in group discussions. The Past Medical History tab (90) brings the user to the section where he or she can enter, edit, or modify elements of his/her past personal medical history. When clicked, the Past Medical History page looks virtually identical to many of the intake forms patients see every time they visit a doctor's office or clinic. In order for patients to avoid having to fill out the same or similar forms every time they visit a provider (either a new provider or one they have visited before but not recently), the patient needs only link with the provider and give the provider access to their Past Medical History. The provider can print these forms off of the network by using the print button (60) on the provider home page and then place them in the patient's chart. Patient allergies can be accessed using the Allergies tab (100) on the left panel. Patients are free to add, edit, and share at will. The allergies section, also, is virtually identical to that seen on forms presented to patients every day in clinics around the country.

The current medications of the patient can be accessed, edited, and shared by clicking the Current Medicines tab (110), also on the left of the page in FIG. 13. On the medicines page, patients can add or delete medicines and provide dosages as applicable. The presence of each medicine in the user's profile can be shared or not, depending on the patient's wish.

The user can access prior surgical procedures by clicking the Past Surgical History tab (120). This list, too, appears on the network as a form similar, if not identical, to many history and intake forms in use in paper form in providers' offices today. Also shown is a list of implanted medical devices (130). Because many of these devices are implanted radiologically and without anesthesia or a scar, patients often forget about them when under duress. By entering them onto the network, physicians will know about them and take them into consideration when planning therapy, and they will not be overlooked.

Copies of a patient's ECGs can be accessed and viewed, added, shared, or deleted on the network by clicking ECG tab (140). If radiographs have been loaded onto the network by the patient, they can be viewed, edited, shared, or deleted by clicking radiographs tab (150). Users can access and view the privacy policy and terms and conditions of network use of the Invention by clicking Privacy Policy (160) and Terms and Conditions (170) tabs respectively. If a user has shared an entire section, or some contents of a section, with a linked provider, this is indicated by a “Shared” icon (180) positioned against a given section. Below the profile picture is the update feed 290, and on the right is a list 260 of persons or organizations with whom the patient's data has been shared.

On the right of the patient's network page in FIG. 13, there is also a list of the actively shared components. The column header (210) is shown, with providers listed down the column. The time remaining in a particular share is shown within the profile window of the linked provider (220). The section or sections of shared data are also listed (230), and the name (240) and profile picture of a linked doctor (250) is also shown. A complete list of those entities with whom a person has shared data is found by clicking the Complete List tab (260). The update feed (270) for the network is shown on the center lower panel. This panel is the nerve center for the network, and a log of all network activity from the user's point of view is displayed here.

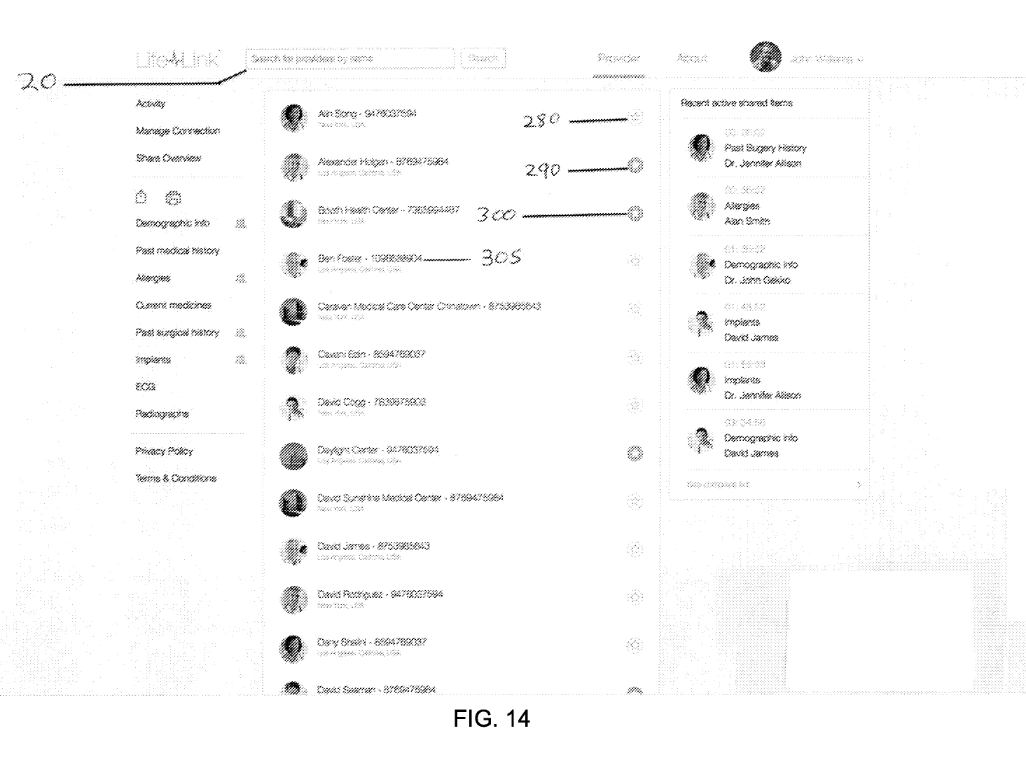

FIG. 14 represents the results from a search inquiry of the network's subscribers performed by the user. Search bar (20) is shown at the top of the page, and the results below it. In the center panel is a list of providers that have been retrieved in the search functions, and their government- or society-issued registration numbers. Shown is a provider with whom the user is not linked, as evidenced by empty star (280). In contrast, the solid or colored star (290) demonstrates that the user has linked with an individual physician, and an organization (300), e.g., a medical clinic. Any given provider is shown (305) with its respective location and registration number.

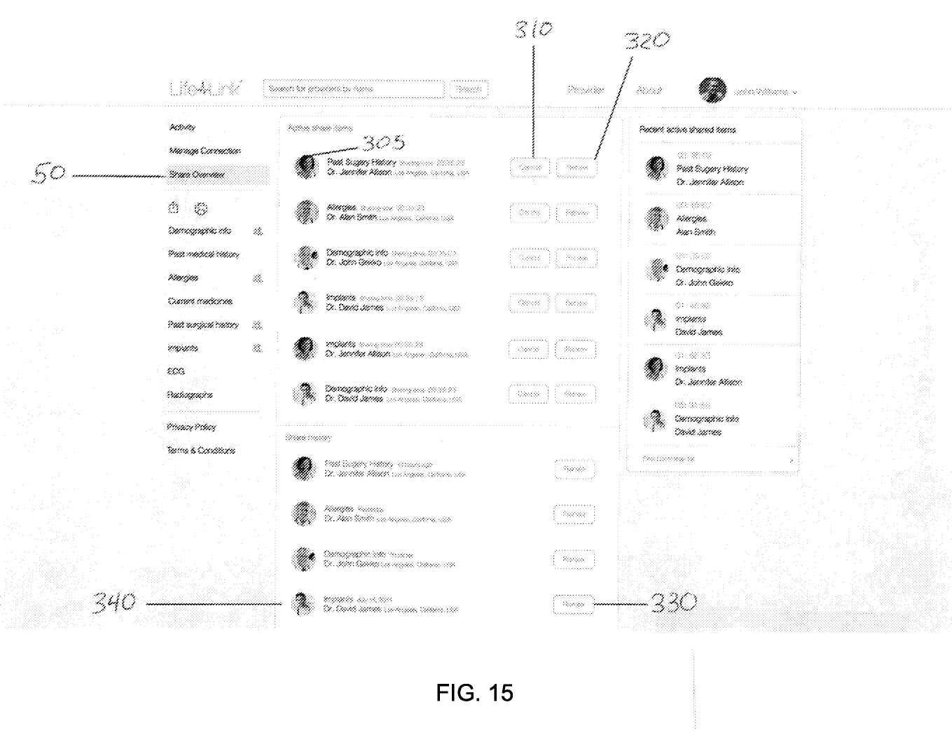

FIG. 15 demonstrates the management of sharing with linked providers. On the top center panel are active shares, and the share history is below. The user accesses this page by clicking Share Overview tab (50). The user, in this example, is linked to a physician (305) and to the right of the profile listing are two buttons, Cancel button (310), and Renew button (320). This physician is actively linked with the user, and the user is being prompted to either renew the link for a specified time period, or to cancel it. On the lower panel, there is a physician (340) who has not recently been linked with the user, but has in the past. To renew the link, the user must simply push renew button (330). These formerly linked contacts listed here simplify the process of the user finding those physicians they have used before, rather than having to re-search for them using the search bar (50).

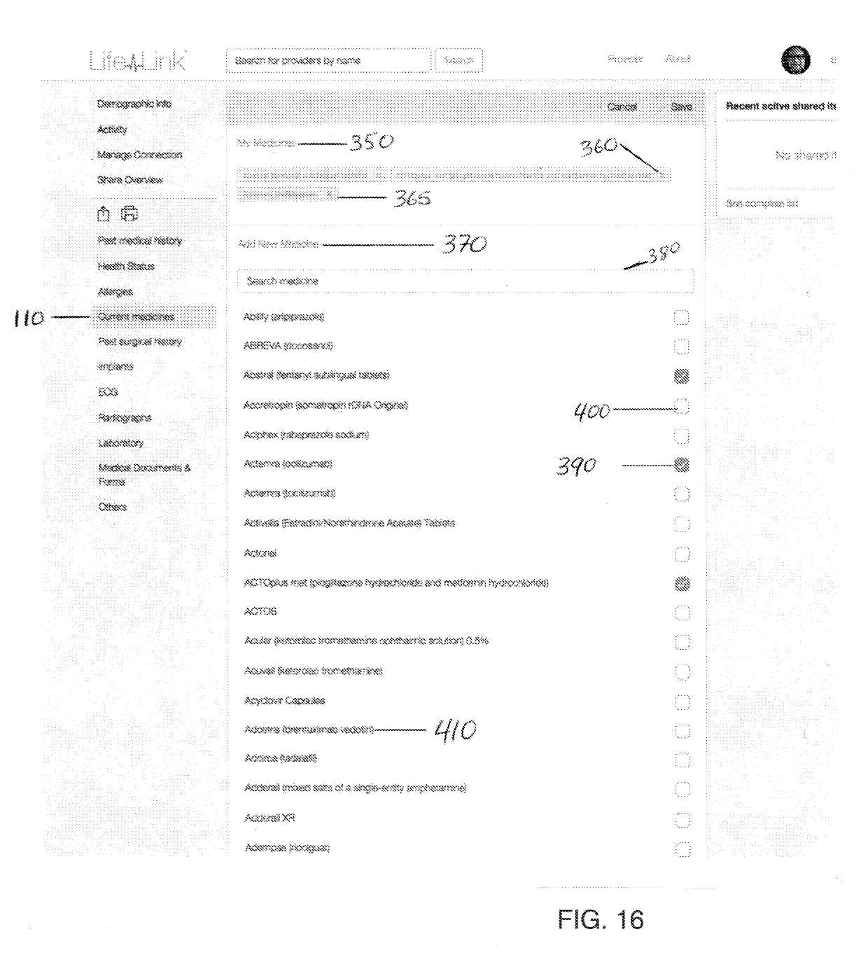

FIG. 16 illustrates how a user manages their medicine list (350). To place a medicine into the user's network, the user first clicks on the tab to “Add new medicine” (370). The user then searches for a specific medicine on the medicine search bar (380), and choices pop up on the screen under the bar (410). When the user wishes to add it to the My Medicines list (350), the user clicks the “+” sign, and it is added. The medicine is not initially added (400), but when the “+” sign is clicked, it becomes “checked” (390) and populates the My Medicines list (365). To remove the medicine from the list, one simply clicks the “X” (360).

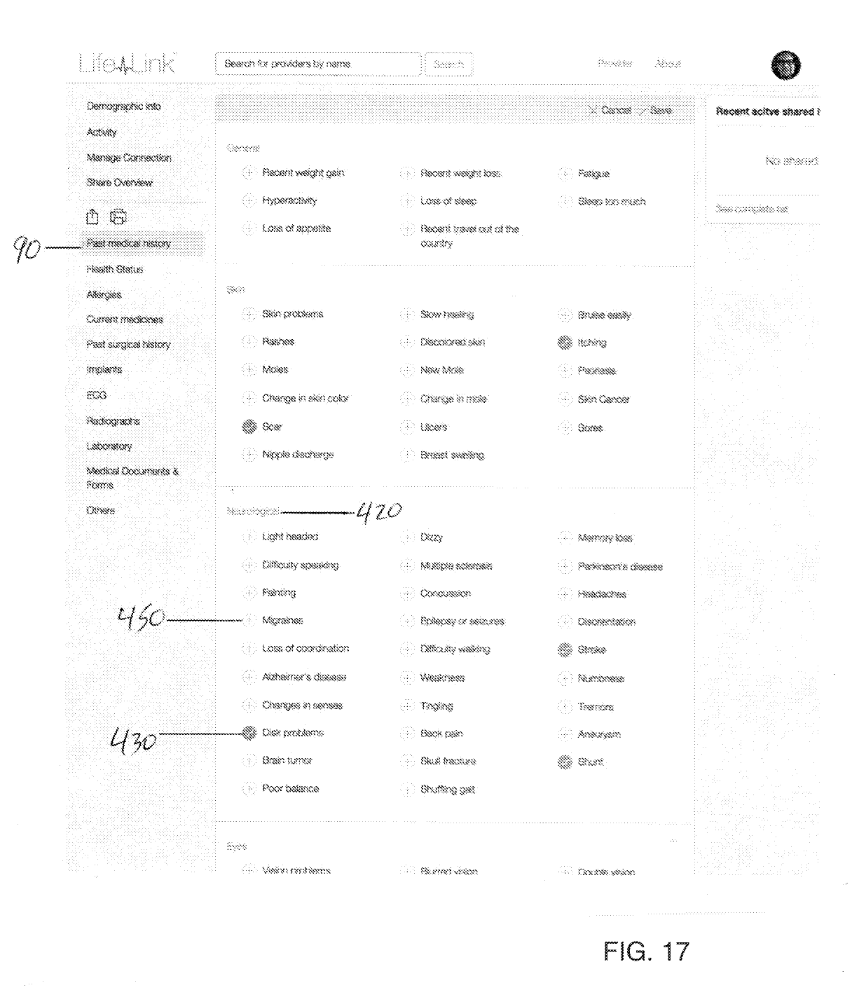

FIG. 17 illustrates an interface to enter a user's past medical history into the network. The user can access this interface by clicking Past Medical History tab (90). Note that the lists and categories are very similar to the intake forms that patients fill out every day when they visit their doctors. The conditions are separated into categories (420), e.g., neurological. A checked condition (430), meaning a condition that the patient has suffered, and an unchecked condition (450) are shown.

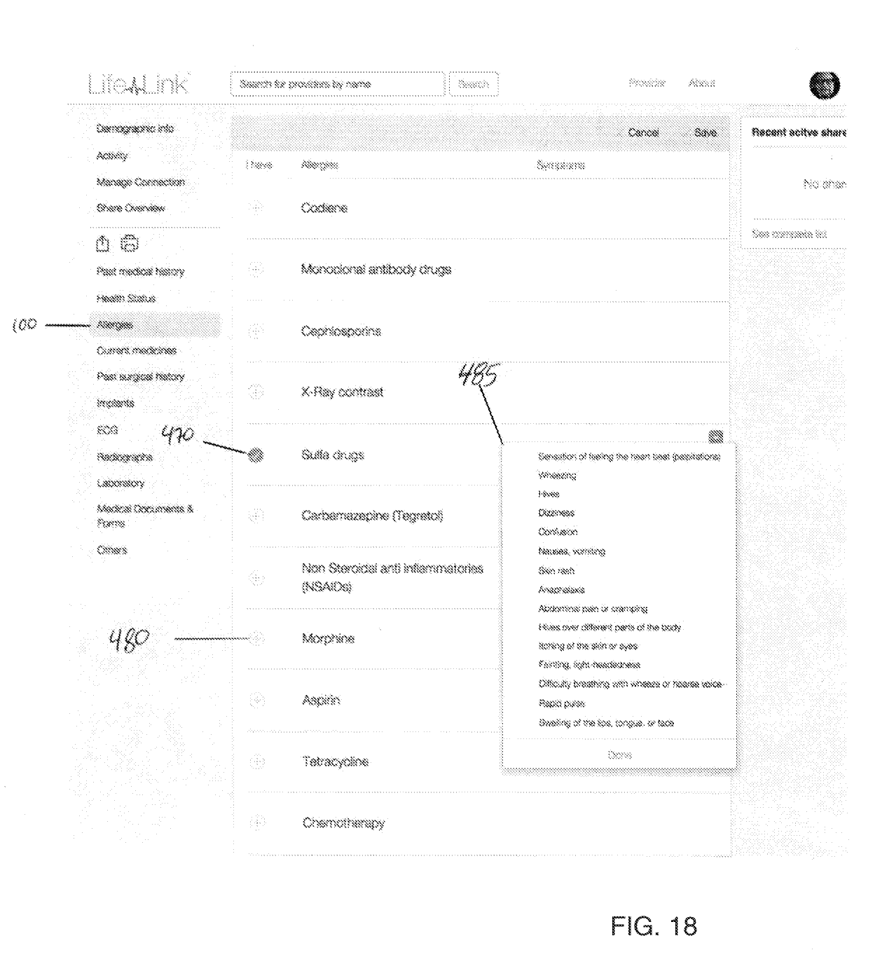

FIG. 18 demonstrates the network page when Allergies tab (100) is pressed. On the top, there is a share notification bar (460) noting that the data has been shared, and with the number of members. The filled checkmark next to a medicine (470) illustrates that that allergen from the list has been shared. The “+” sign next to another entry (480) demonstrates that this element has not been added or is not an allergy of this user. Because there is significant variability of allergic responses between individuals, there is a box provided (485) that allows the patient to detail the severity of the allergy.

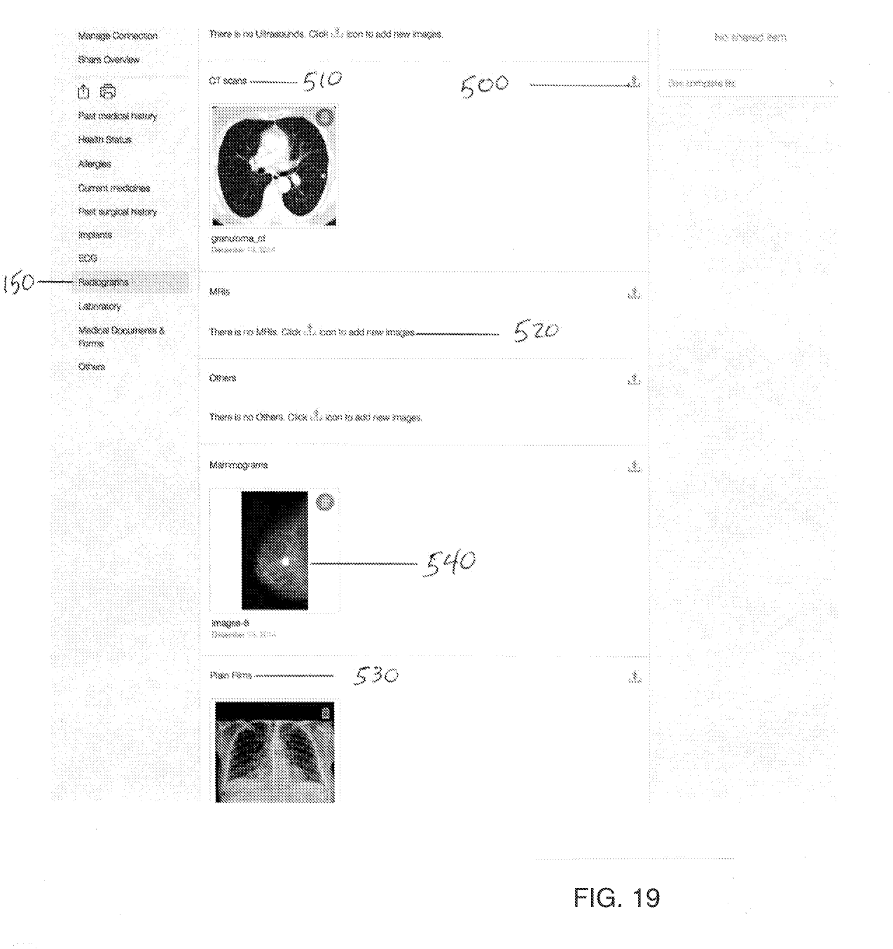

FIG. 19 is an exemplary page that appears when Radiographs tab (150) is clicked. In this section, the patient is free to load his or her prior radiographic studies onto the network. The patient simply needs to push the load button (500) and the network will provide a search box that will allow the patient to find the appropriate images on his or her computer. These images can also be supplied from a hospital or imaging center, or as electronic files from another source. In the page shown, the films are organized by radiograph type, e.g., plain films (530) or CT scans (510). If no films matching a given criterion are present, the user is notified (520). A representative thumbnail of an image (540) with the date is shown.

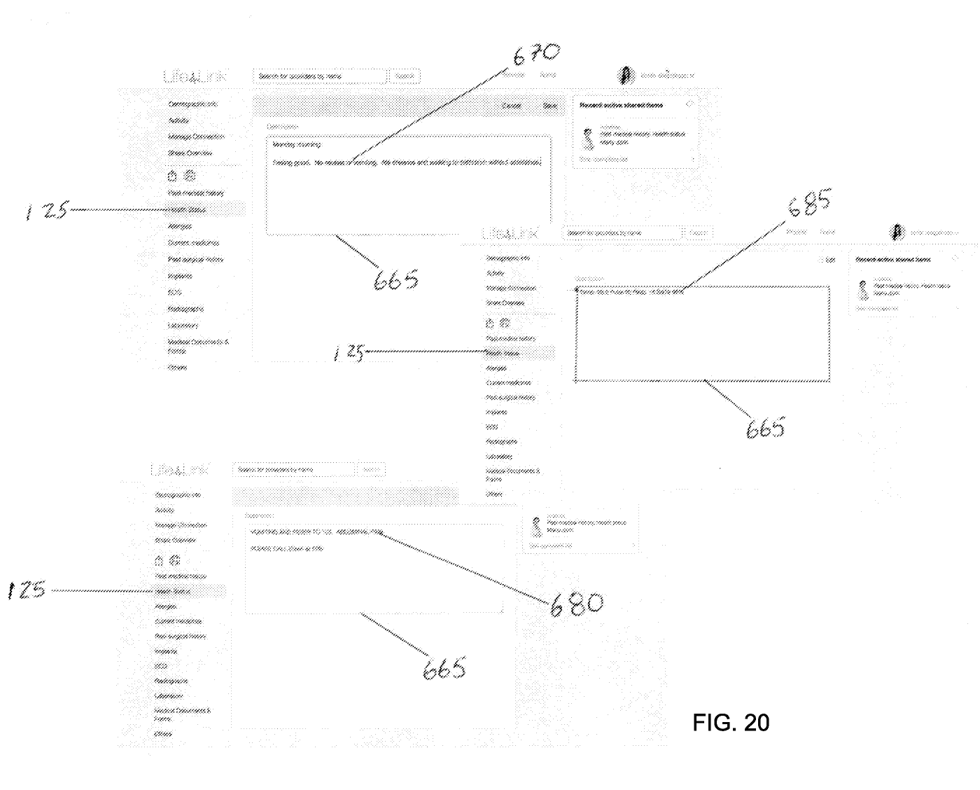

FIG. 20 demonstrates how the entries in FIG. 7 might appear in the invention's Health Status window. The top panel contains a free text notation from a patient who is doing well post discharge (670). This note can go immediately onto the news-feed of all providers or clinical entities who are linked to the patient at the time of posting. The middle panel contains data generated by an electronic wearable health-monitoring device (685). This data can be placed into the health status bar (665) and transmitted to the care team as would free text. The lower panel depicts free text entered by a caregiver stating that the patient is not doing well, and lists a phone number to call. When posted, all linked persons will immediately receive this message, and the responsible party can follow up.

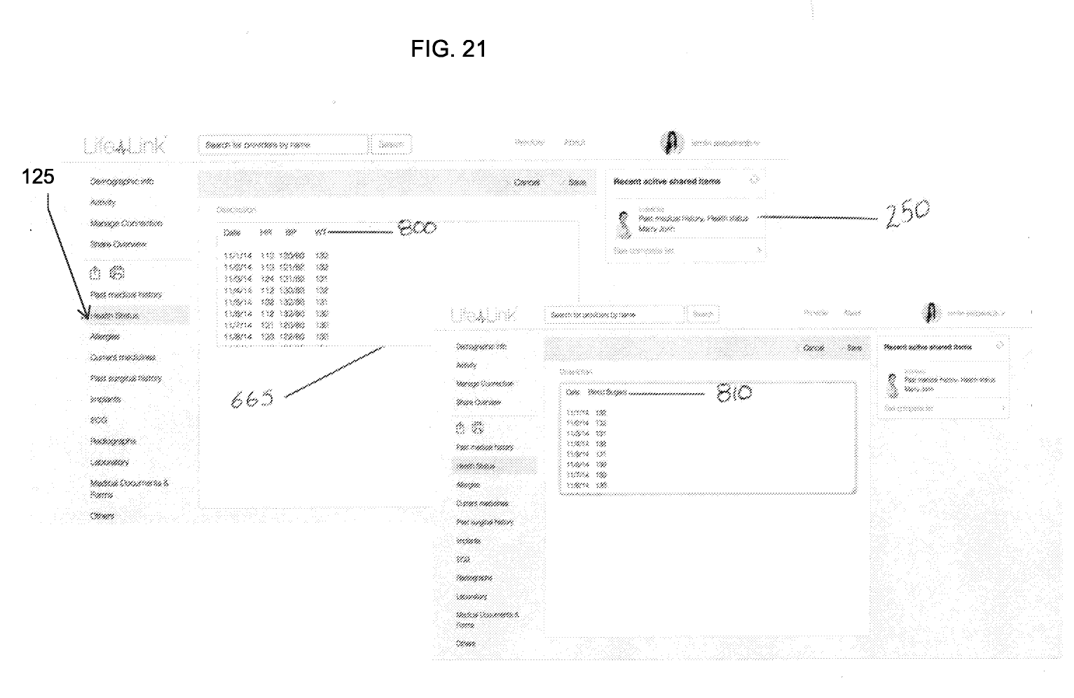

FIG. 21 displays two examples of the invention being used to assist in a wellness program. In these screens, data is entered from an electronic health-monitoring device. In the upper panel, fitness data (800) from a wearable health-monitoring device has been entered into the Health Status bar (665) and has been shared with a provider (250). In the lower panel, blood sugar measurements (810) have also been shared with the same provider. Note that in this case, only the past medical history and the health status have been shared with this provider. All other aspects of the patient's health history have not been shared. The invention is perfectly suited to monitor chronic diseases such as diabetes, or general health metrics remotely as part of a wellness initiative.

### Computing Apparatus

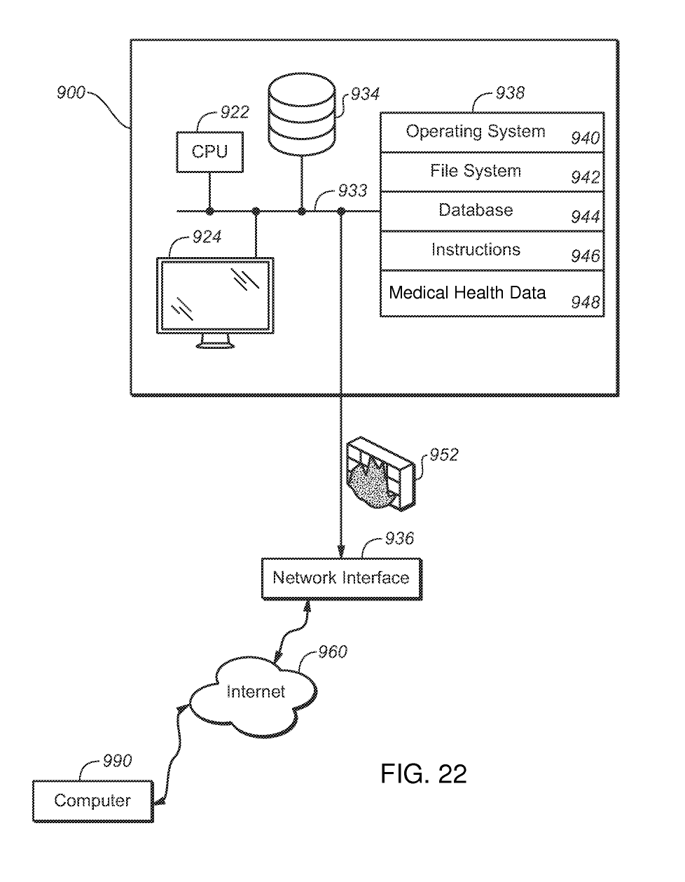

An exemplary general-purpose computing apparatus 900 suitable for practicing the invention described herein is depicted schematically in FIG. 22.

The computer system 900 comprises at least one data processing unit (CPU) 922, a memory 938, which will typically include both high speed random access memory as well as non-volatile memory (such as one or more magnetic disk drives), a user interface 924, one more disks 934, and at least one network or other communication interface connection 936 for communicating with other computers 990 over a network, including the Internet 960, as well as other devices, such as via a high speed networking cable, or a wireless connection. There may optionally be a firewall 952 between the computer and the Internet. At least the CPU 922, memory 938, user interface 924, disk 934 and network interface 936, communicate with one another via at least one communication bus 933.

In a client-server implementation, computer 900 can be just one client computer of a large number of such client computing devices, and computer 990 can be a server computer.

Memory 938 stores procedures and data, typically including some or all of: an operating system 940 for providing basic system services; one or more application programs, such as a compiler (not shown in FIG. 22), a file system 942, one or more databases 944 that store electronic medical records, instructions for, e.g., searching electronic medical records 946, and patient medical health data 948. The methods of the present invention may also draw upon functions contained in one or more dynamically linked libraries, not shown in FIG. 22, but stored either in memory 938, or on disk 934.

The database and other routines shown in FIG. 22 as stored in memory 938 may instead, optionally, be stored on disk 934 where the amount of data in the database is too great to be efficiently stored in memory 938. The database may also instead, or in part, be stored on one or more remote computers that communicate with computer system 900 through network interface 936.

Memory 938 is encoded with instructions for receiving input from a patient, and receiving database access requests from third parties such as family members, medical professionals, and healthcare organizations. Instructions further include programmed instructions for sending messages to other users, assigning access levels to medical data, providing social network functions, and categorizing patient medical data.

Various implementations of the technology herein can be contemplated, particularly as performed on computing apparatuses of varying complexity, including, without limitation, workstations, PC's, laptops, notebooks, tablets, netbooks, and other mobile computing devices, including cell-phones, mobile phones, and personal digital assistants. The computing devices can have suitably configured processors, including, without limitation, graphics processors and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface 924, which may comprise a mouse, keyboard, and/or other items not shown in FIG. 22, such as a track-pad, track-ball, touch-screen, stylus, speech-recognition, gesture-recognition technology, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of patient medical information processed in batches, or by interaction with a user who inputs specific instructions for an electronic medical record.

The patient data manipulated by the technology herein can be displayed in tangible form, such as on one or more computer displays, such as a monitor, laptop display, or the screen of a tablet, notebook, netbook, or cellular phone. The data can further be printed to paper form, stored as electronic files in a format for saving on a computer-readable medium or for transferring or sharing between computers, or projected onto a screen of an auditorium such as during a presentation.

The computer functions for carrying out the invention can be developed by a programmer of skill in the art. The functions can be implemented in a number and variety of programming languages, including, in some cases mixed implementations. For example, the functions as well as scripting functions can be programmed in C++, Java, Python, VisualBasic, Perl, .Net languages such as C#, and other equivalent languages not listed herein. The capability of the technology is not limited by or dependent on the underlying programming language used for implementation or control of access to the basic functions.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, iOS5, and iOS6 and intervening updates to the same); Apple Macintosh operating systems such as OS9, OS 10.x (including but not limited to variants known as “Leopard”, “Snow Leopard”, “Lion”, and “Mountain Lion”); the UNIX operating system (e.g., Berkeley Standard version); and the Linux operating system (e.g., available from Red Hat Computing).

To the extent that a given implementation relies on other software components, already implemented, such as functions for basic mathematical operations, those functions can be assumed to be accessible to a programmer of skill in the art.

Furthermore, it is to be understood that the executable instructions that cause a suitably-programmed computer to execute methods for linking patient data together, as described herein, can be stored and delivered in any appropriate computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can also be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

### EXAMPLES

### Example 1

### Being Admitted to the Hospital Overnight Because the ER Doctor Couldn't Compare a Patient's Old EKG with a New One

One of the most commonly encountered complaints in the hospital emergency room is “chest pain”. Although there are many potential etiologies of chest pain, the one that strikes the most fear amongst both patients and providers is cardiac chest pain. Almost immediately upon entering the Emergency department, a patient is given medicine, and a 12 lead ECG is obtained. If the ECG is “abnormal” but is not diagnostic of an acute myocardial infarction (heart attack), it is very useful to review the patient's old ECG to determine if there are “changes” between the ECGs to indicate an acute cardiac process. In many cases, however, the old ECG is from another hospital, is buried in old paper records, or was obtained at the doctor's office and is unavailable. Given an “abnormal ECG” and no clear and convincing evidence that the ECG changes are old, a patient is almost always admitted to the hospital to “rule out” a myocardial infarction.

The outcome could be vastly different by using the network described herein. The patient, or his/her representative, “links” with the emergency room upon entering the ER, or, if a mobile device is being used, in the ambulance on the way to the hospital. The treating physicians have access, not only to the old ECG, but the patient's past medical history, past surgeries, and list of medicines. The physicians are able to begin thinking of differential diagnoses (if the pain is non-cardiac). In this case, a physician notices that the patient also has a hiatal hernia and is currently being treated for reflux disease. After reviewing the history with the patient, and excluding acute ECG changes, the physician is able to state with confidence that the pain is reflux related and not cardiac. Consequently, the patient avoids an admission to the hospital and avoids further diagnostic testing.

### Example 2

### Having to Repeat (and Pay the Deductible) for Lab Tests and X-Rays Simply Because they were Done at a Different Facility

Over the past several years, employees have been changing jobs much more frequently. Since a large percentage of health insurance is employer provided, employees and their families have needed to change insurance carriers much more often. And, since the carriers are different, the in-network physicians and hospitals are typically different too. Consequently, patients are changing facilities and providers frequently, leaving their old tests and records behind. Fallout from the Affordable Care Act also encourages use of Urgent Care Clinics. These facilities, often owned by many different companies, rarely communicate with each other. One clinic rarely knows what the other has done, except by way of the patient. The network can be accessed to document clinic visits, flu shots and vaccinations. The patient (or the facility if given permission) simply needs to upload the information to the patient page in the network. That way, wherever the patient goes, to hospital, clinic, or doctor's office, everyone knows what was done, when, and where.

A common situation is that, following a change in employment or insurance, a patient's new physician will want to get a complete picture of his or her new patient to avoid missing an easily diagnosed red flag. Almost certainly, this complete picture will include new blood work, a new ECG, a new chest x ray, and possibly a new cardiac stress test or abdomen ultrasound, “just to be on the safe side”. These tests are very expensive, and will also take quite a bit of time to schedule and perform. Additionally, every test carries the real risk of a false positive result, which could potentially lead to a biopsy or surgery, “just to be on the safe side”.

This new-patient introductory procedure and the subsequent retesting associated with it can happen over and over again with every new physician the patient or his/her family encounters when they change jobs or insurance carriers. With the advent of the Affordable Care Act, patients and employers are using more “High Deductible” health plans. That means, until the deductible is paid, the patient has to pay for these repeat tests out of pocket. The direct cost to patients can add up to hundreds, even thousands, of dollars.

Accessing data on exemplary implementations of the Invention can be of major help here. The old tests can be clearly and unequivocally stored in the network and retrieved by the new physician when given access. Typically, there is no need to repeat tests on asymptomatic patients, and the new doctor can get a complete picture by using the recently obtained results, even though they may have been obtained at a different facility. Utilizing the network will save not only a great deal of money, but will save a great deal of time wasted getting the tests. The new doctor will also have the medical history, allergies, and specialist notes. Accessing the network will give the new doctor a much more complete picture than he/she could have had simply by ordering additional tests. The new doctor can see the consultant notes and the radiograph reports from the past. If given permission by the patient, he/she can download the patient's information and populate his Electronic Medical Record, or print out the data to keep in his paper file, fast and easy. Given a HIPAA release, the Invention can, by serving as a standardized bridge (for example, using the-EMRlink); easily transfer data between EMRs. In this case, some or all of the EMR data from one EMR vendor can be transferred to the bridge and sorted by date of service. The record is then collated by, for example, the EMRlink and provided to the patient or another provider depending on the permission given by the patient. The patient can provide a copy of his/her network page on a CD or by email to a new doctor, a family member, or an urgent care clinic. It is a win-win for both doctor and patient.

### Example 3

### Having to Reschedule Your Appointment with the Breast Surgeon when You Realize that You Left Your Mammograms on the Kitchen Counter

Often patients are asked to “bring their X-rays” when seeing a specialist. This is especially true when a patient is seeing a breast surgeon for the first time. Typically, a patient has her screening and diagnostic mammograms taken at one facility several weeks earlier, and then travels to a different facility to see the surgeon. A critical part of surgical planning is provided by the mammographic findings, and a complete evaluation cannot be provided without the X-rays.

More commonly than you might expect, the patient arrives at the surgeon's office without the mammograms. Whether the patient thought that copies of the films were sent to the surgeon by the hospital, or the films were left at home accidentally, the fact is that the surgeon cannot provide an opinion on the best course of action without the films. The patient must reschedule her appointment and bring the mammograms next time.

The ability to access exemplary implementations of the Invention can eliminate the need to bring films to the appointment, and can reduce the anxiety inherent in the entire process. The patient and physician can “link” using the network the day before the appointment, and the doctor can review the films ahead of time. The doctor can plan her words carefully to help the patient understand the procedure before the patient arrives, rather than spend valuable appointment time evaluating the mammograms for the first time with the patient in the room. There will be no need to cancel and reschedule appointments due to lost or absent radiographs, because the films will be on the server. The surgeon need only log in, and the mammograms can be viewed in the radiographs folder. The patient is free to get her pre-op testing done at whatever facility she (or her insurance provider) chooses. The lab work and the chest radiograph can be loaded onto the network as they are obtained. Prior to surgery, the patient can give access by linking to the surgical center. The anesthesiologist can look at the chest X-ray, the medications, the past medical history, and allergies prior to surgery. Importantly, the network also asks whether there has been any trouble with prior anesthesia. If the patient has medical issues before or after surgery, the internist can access the old records for clues on the present situation, even if the exams and data were generated at multiple facilities around town or around the country.

### Example 4

### Leaving Your Father Alone in the Emergency Room while You go Home to Retrieve his Medicine Bottles for the Doctor

As patients get older, they often see a large number of doctors, each performing tests, providing recommendations, and prescribing medicines. For older patients, it is a challenging to keep all of the doctors and the medicines straight. When there is an emergency, this confusion can prove dangerous. Doctors in the emergency room often practice medicine in a vacuum, and the consequences of an adverse reaction to a treatment, or a medicine interaction can prove fatal. For this reasons, patients or their caregivers try to bring a large baggie filled with medicine bottles to the emergency room to help the treating doctor sort it all out. In the thick of an emergency at home, however, it is not always possible to remember the medicine bottles or records.

Using the network can be very helpful here. Linking to the emergency room would give doctors access to the patient's past medical history, medicines and doses, allergies and other critical health information. A caregiver would never have to leave the hospital to retrieve medicine bottles and records from home—they would all be loaded on the network. Should the patient be admitted, the patient (or his/her caregiver) need only provide access to the hospital staff taking care of the patient. It is common for an elderly patient to be admitted emergently in Hospital A, discharged, and then is admitted to Hospital B several days later. In cases such as these, it is desirable for the records to be under control of the patient (or the patient's designated representative), so they are available to anyone who needs them, regardless of where the patient is at the time.

### Example 5

### Having to Follow Up a Lesion on an X-Ray for Two Years Because the Radiologist can't Prove that the Lesion is Old

X-rays are one of the most commonly acquired medical tests. X-rays are only a snapshot of a disease process: a single point in time. Some radiographic lesions are diagnostic of cancer on the first film—no additional non-invasive testing is needed. Most lesions on X-ray, however, need context and comparison films to arrive at a correct diagnosis. Unfortunately, unless the patient has only been seen at one facility, the old radiographs are rarely available. Every imaging center has its own radiograph archiving system, and even branches of the same hospital often have computer systems that do not communicate effectively. The inability to compare current films with old ones can lead to serious problems.

The study of lung cancer on X-ray is a suitable example. Any nodule in the lung could be lung cancer. Lung cancer, caught early enough, can be cured, whereas late stage lung cancer is often fatal. Radiologists are trained to keep a close eye on pulmonary nodules to see if further work up such as biopsy or PET scanning is warranted, to avoid late stage cancer. One of the key tools available to radiologists are the old films. If a lesion is growing over six months, then it is suspicious. If it has been stable for five years or more, it is very unlikely to be cancer. In the absence of old radiographs to document stability, indeterminate lung lesions get follow-up CT scans every six months for a total of two years to document stability.

By accessing an exemplary implementation of the network of the invention, the provider can view the old films, if they have been loaded onto the network. If a scan from a different facility shows the lesion to be stable—the patient is done. No more follow up scans, no PET scan, and no biopsy. All of the time, radiation exposure, and expenses associated with two-year follow up are eliminated. An exemplary implementation of a window of the Invention can be easily incorporated into a hospital and imaging center PACS system using well-established DICOM protocols. The PACS can allow a radiologist to load exams from the Invention's window in the PACS browser or onto an adjacent computer, and the old films will populate the reading panes. In this way, radiologists can compare the new films with the films archived in the Invention's network.

A non-PACS networked computer screen or screens can be pulled up along side of the department PACS screens to compare images directly from the Life-Link Network with those on the PACS screen without integration into the hospital PACS.

### Example 5

### Being Able to Get Several “Second Opinions”, without Leaving Your Hometown

Most diagnoses of cancer are made at community hospitals. This is not necessarily because community hospitals are better at diagnosing or treating cancer, but is simply a reflection of the fact that most patients go to their local doctors and hospitals for routine check ups, rather than travel to the tertiary care centers that are often located downtown in large cities. Although community medical centers often provide superior care for routine diseases and surgical problems, they are not typically the best suited to handle rare diseases or difficult cancers. Patients know this, and often would like to get a second opinion from a team in a University Medical Center that has more experience with their particular problem. But, getting in to see those specialists in the major centers can be a Herculean task.

Often cancer patients carry their medical information from doctor to doctor in small suitcases filled with X-rays, lab data, and binders of physician notes. By using an exemplary implementation of the invention network, the electronic portability problem of medical records is eliminated.

Much of the work done by the team at a tertiary center involves reviewing the data, procedure notes, and radiographs obtained at the community hospital. By reviewing all of this data, and talking to the patient on the phone, a pretty good idea of the treatment options can emerge without the patient even having to meet the team in person. An exemplary implementation of the invention is the perfect mechanism to allow the team at the major medical center to review the patient's data, notes, and studies without having the patient travel hundreds or even thousands of miles away. The team can review potential consults and new patients much more quickly than if the patient were in the office, and the patient can review several teams and their approaches without leaving home.

The patient simply needs to link with the team's provider site and the team can review all of the accessible data. They can then speak intelligently on the phone, rather than waste both the team's time and the patient's time. The patient can use the network to link with several different teams in different cities and compare approaches. Because this is a social network, only the patient knows whom he/she has linked with, and the providers do not know that the patient is comparison-shopping.

Patients can also access the invention when considering routine elective surgeries, such as hip replacements. Medical costs vary widely from region to region, and even hospital to hospital. Now that patients are paying a lot more out of pocket for treatments and procedures, they are very elastic when it comes to price. Patients can price shop among providers for the best deal. Consequently, the price transparency provided by the network can serve to keep costs down.

### Example 6

### Providers can Monitor Patients from Home to Head Off Costly Hospital Admissions

When a patient is admitted to the hospital, hospitals are often paid a flat fee to cover the admission based on the admitting diagnoses. If a hospital is efficient, and the patient is discharged early, the hospital can save money. If the hospital is disorganized, the thinking goes, they should be penalized and not reimbursed for the extra day in hospital. Not surprisingly, hospitals discharge their patients early and collect the money, hoping that the patient will be ok. But, often patients are not OK, and need readmission to the hospital. Currently, CMS (the government Medicare administration service) and insurers are penalizing hospitals significantly for readmissions. Fortunately, the network is perfectly suited for post-discharge monitoring to avoid readmission.

For example, when a patient is discharged, he/she “links” with the discharge monitoring team at the hospital. The patient (or caregiver) is instructed to take his/her vital signs at specific times and post them on the patient's network home page. As vitals are entered, the data pops up on the discharge team's home page update panel. The team can then call or follow up with the patient depending on the severity of the posted abnormalities.

Similarly, providers can easily monitor patient postings to follow patients with chronic diseases like diabetes. Data from blood sugar measurements, Pulse Ox, telemetry, and so forth can all be monitored on the update panel by whichever facility or provider has been given permission by the patient. This feature could save countless hospital admissions and adverse health events.

### Example 7

### Having Your Primary Doctor Ask You how Your Cardiology Stress Test Went and Ask You if the Cardiologist Put You on any New Medicines

Primary doctors very commonly get left out of the discussions when a patient goes to see a specialist. Once a primary physician refers a patient, often that patient is lost to follow up. Medicines are often changed or added by the specialist and the primary has to find out via the patient. The network can be used to provide this much need link and support continuity of care. In the network, both specialist and primary physician can be linked via a common patient. When the specialist provides a recommendation or dictates a procedure note, the patient can upload (or authorize the specialist's office to upload) a copy of the results to the network. The patient's primary doctor, having been linked to the patient on the network, will see the specialist's report and recommendations pop up on his or her home page update panel. In this manner, the primary physician will be able to keep tabs on his/her patient's visit and integrate it with the patient's total care. Primary doctors will be enthusiastic adopters because, not only will it improve the holistic health of the patient, but it will also demonstrate to the patient that the primary physician is in the loop and knows what's going on.

### Example 8

### Being Able to Communicate with Your Doctor's Office from Remote Locations

Getting in to see the doctor can be a daunting task. Often the doctor is a great distance away or is difficult to reach for other reasons. There are many types of non-emergency visits to the doctor, some that take far longer to drive to the office, park, fill out forms, and wait, than time spent being seen. Certain visits, like interactions with the dermatologist or well-child checks at the pediatrician, can last only 5 minutes. Using aspects of the invention can be a great help in these situations. Patients can link up with their dermatologist and post photos of a worrisome mole. The dermatologist can often take one look and make a diagnosis. If it is, for example, a lesion of seborrheic keratosis, the patient can be reassured. If the dermatologist finds the lesion worrisome, or doesn't know what it is, the physician can advise the patient that he/she needs to come in. Lesions such as melanoma can be given priority so that the patient does not have to wait the three to four weeks for a routine appointment. This “triage” system facilitated by the Invention will allow those patients with serious problems to be seen sooner, while allowing the patient with benign findings to stay at home or work. The use is not limited to dermatologic use. For example, a neurologist could review a posted video of a tremor, or evaluate a video of a patient's gait as he/she walked across a room.

Often patients are asked to take diagnostic tests while in the office, e.g., color blind testing. This takes a large amount of time, and can utilize scarce resources in the office while the test is completed. Using aspects of the invention can be of help here. The patient can be given the exam by email or by visiting a web page, and the patient can post his/her answers on his/her home page. When the patient posts answers to the test, a notification will pop up on the doctor's office update panel for review.

The pediatrician's office can be a cacophony of bodies and screaming children. Some of the children in the office have viruses or other communicable diseases, whereas some are simply “well” and need a routine visit to lay a “set of eyes” on the child. There is no need to expose “well” children to the bevvy of viruses in the office. Aspects of the invention can be a huge help. The physician can establish a set of tasks for mother to perform with her child-be it a “well baby” check or a woozy child staying home from school. The mother can video these tasks and post it on the network. The pediatrician's office can review their update panel and watch 20 well baby videos in the time it takes to see two patients in the office. If the nurse or doctor senses something out of the ordinary, the office can ask mom and baby to come in. Not only will exemplary embodiments of the invention minimize the chance for a well child to catch a cold (or worse) at the doctor's office, remote evaluation will save countless hours both for the patient, the patient's mother and siblings, and for the providers.

### Example 9

### Patients can Educate Each Other and their Providers . . . and Providers Educate their Patients . . . and Providers can Educate Each Other

Because the invention comprises a social network, all providers with whom the patient is linked can see updates by a patient to his/her network page. Should the patient wish to post an interesting article about his/her particular disease, or a new treatment out of, for example, Mexico, it will pop up on the provider's update panel. Patients can use this network to link with other patients to share similar articles, or post on a group update panel hosted by an organization. For example, there are charitable organizations that concern themselves with multiple sclerosis, and who can start a group on the network. Patients can “link” with the group and post if they wish. The demographic information allows for an “alias” to be used for group communications, should a patient want to remain anonymous. Patients can use this group to share tips on health and wellness in patients with multiple sclerosis. This functionality is especially useful in patients with rare diseases, e.g., von Willebrand's or Gaucher's disease who might be spread across the country. The network can serve as a clearinghouse for new treatments and recommendations, as well as providing social and emotional support to members who may have felt alone and that no one understands them. If an expert joins the group, these group discussions can be moderated.

Conversely, providers and organizations can use the social network group functionality to communicate with those patients who have chosen to link with the group. Health Insurance companies, accountable-care organizations, or employers often have “wellness initiatives” that they would like their patients to be aware of. Some of these offer rewards or other incentives to patients who reach certain standards of exercise or weight loss. Using the network, these organizations can reach out to interested patients, i.e., those who are linked, and the notices will appear on the patient's update panel. As stated above, the patient can post compliance or milestone data on their page, should they so choose. In the Provider layer, other organizations, e.g., malpractice insurance carriers can share risk management information to specific specialties of physicians, or CME providers can link CME to specific (and relevant) occurrences in the network. Third party medical information content providers, e.g., Up-To-Date, can also link their content to data found in the network in either the patient's or provider's layers.

In the HIPAA-compliant layer, physicians can link with each other and discuss care of a specific patient or a group of patients, e.g., at an upcoming hospital cancer conference. Physicians and other professional caregivers can caucus electronically about any number of sensitive issues.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

What is claimed:

1. A computer system for managing access by multiple parties to electronic medical data, the system comprising:
a server configured to:
receive electronic medical data from a plurality of patients; and
provide access to the electronic medical data by a plurality of third parties,
wherein the server is connected to a network of computing devices,
wherein the server and network of computing devices are configured to provide social network functions to the plurality of patients and the plurality of third parties,
wherein the third parties are selected from: family members, doctors, medical facility staff, insurance providers, and other patients;
a database of electronic medical data from the plurality of patients, stored on the server;
at least one computing device configured to accept a patient's electronic medical data, wherein the data comprises a plurality of items of information;
an interface on the at least one computing device through which the patient optionally assigns to each item of information an access level, wherein the access level determines which third parties have permission to access the item of information,
a network connection configured to transmit the patient's electronic medical data to the database; and
at least one computing device configured to permit one or more of the third parties to access the items of information according to the access level for each item of information.

2. The system of claim 1, wherein the social network functions include:
messaging between one or more of the plurality of patients and one or more of the plurality of third parties, amongst the plurality of third parties, and amongst the plurality of patients,
establishing connections between the plurality of patients and the plurality of third parties, amongst the plurality of third parties, and amongst the plurality of patients,
communicating updates from a patient to one or more of the plurality of third parties to which the patient has established a connection,
message-board functions for topics of interest to the plurality of patients, to which the plurality of patients and the plurality of third parties can post information, and
tools for patients to create, edit, and publish summaries of their personal history for viewing by other patients and the plurality of third parties.

3. The system of claim 1, wherein the plurality of patients may share information about costs of a medical procedure or product with one another, by one or more of: posting the information on one or more message-boards in the social network; and sending messages to other patients with whom they are connected.

4. The system of claim 1, wherein the information about costs includes geographic information, costs charged by different providers, and cost variations over time.

5. The system of claim 1, wherein the plurality of third parties may share information about costs of a medical procedure or product with one another, by one or more of: posting the information on one or more message-boards; sending messages to other third parties with whom they are connected.

6. The system of claim 1, wherein the plurality of third parties includes the care team for a patient, and wherein the patient establishes one or more connections with the care team, and gives the care team permissions to access the patient's electronic medical data.

7. The system of claim 1, wherein the electronic medical data includes one or more of: ECG's, X-rays, MRI scans, blood tests, allergies, immunizations, and prescriptions.

8. The system of claim 1, wherein the at least one computing device configured to accept a patient's electronic medical data from the patient is in the patient's home.

9. The system of claim 1, wherein the access level assigned by a patient to each item of information is HIPAA compliant.

10. The system of claim 1, wherein the at least one computing device configured to accept a patient's electronic medical data is selected from: desktop computer, laptop computer, tablet computer, or smartphone.

11. The system of claim 1, wherein he access level further determines whether an individual who can access the item of information can view, edit, print, or copy the item of information.
